(19) United States
(12) Patent Application Publication
(10) Pub. No.: US 2024/0314723 A1
(43) Pub. Date: Sep. 19, 2024

(54) UPLINK-BASED POSITIONING VIA A REPEATER

(71) Applicant: QUALCOMM Incorporated, San Diego, CA (US)

(72) Inventors: Navid ABEDINI, Basking Ridge, NJ (US); Sony AKKARAKARAN, Poway, CA (US)

(21) Appl. No.: 18/183,121

(22) Filed: Mar. 13, 2023

(51) Int. Cl. H04W 64/00; H04L 5/00; H04W 24/10

(52) U.S. Cl. CPC H04W 64/00; H04L 5/0051; H04W 24/10

(57) ABSTRACT

Apparatuses and methods for UL-based positioning via a repeater are described. An apparatus is configured to obtain a SRS configuration for a UE. The SRS configuration includes information associated with positioning of the UE. The apparatus is configured to perform a positioning measurement(s) based on an UL transmission from the UE and the information associated with the positioning of the UE. The apparatus is configured to transmit, for a network node, an indication of the at least one positioning measurement. Another apparatus is configured to receive, from a UE via a wireless device, a set of SRSs. The apparatus is configured to obtain, based on the set of SRSs, an indication of an E2E measurement(s) associated with communications for the UE. The apparatus is configured to transmit, for a network entity, measurement information that includes the E2E measurement(s) associated with the communications for the UE.

### TECHNICAL FIELD

The present disclosure relates generally to communication systems, and more particularly, to wireless communications utilizing positioning.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus is configured to obtain a sounding reference signal (SRS) configuration for a user equipment (UE), the SRS configuration including information associated with positioning of the UE. The apparatus is also configured to perform at least one positioning measurement based on an uplink (UL) transmission from the UE and the information associated with the positioning of the UE. The apparatus is further configured to transmit, for a network node, an indication of the at least one positioning measurement.

In the aspect, the method includes obtaining a SRS configuration for a UE, the SRS configuration including information associated with positioning of the UE. The method also includes performing at least one positioning measurement based on an UL transmission from the UE and the information associated with the positioning of the UE. The method further includes transmitting, for a network node, an indication of the at least one positioning measurement.

In an aspect of the disclosure, a method, a computer-readable medium, and an apparatus are provided. The apparatus is configured to receive, from a UE via a wireless device, a set of SRSs. The apparatus is also configured to obtain, based on the set of SRSs, an indication of at least one end-to-end (E2E) measurement associated with communications for the UE. The apparatus is further configured to transmit, for a network entity, measurement information, where the measurement information includes the at least one E2E measurement associated with the communications for the UE.

In the aspect, the method includes receiving, from a UE via a wireless device, a set of SRSs. The method also includes obtaining, based on the set of SRSs, an indication of at least one E2E measurement associated with communications for the UE. The method further includes transmitting, for a network entity, measurement information, where the measurement information includes the at least one E2E measurement associated with the communications for the UE.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of a UE positioning based on reference signal measurements.

FIG. 5 is a diagram illustrating an example repeater, in accordance with various aspects of the present disclosure.

FIG. 6 is a call flow diagram for wireless communications, in accordance with various aspects of the present disclosure.

FIG. 7 is a call flow diagram for wireless communications, in accordance with various aspects of the present disclosure.

FIG. 8 is a diagram illustrating an example of UL-based positioning measurements via a repeater, in accordance with various aspects of the present disclosure.

FIG. 9 is a flowchart of a method of wireless communication, in accordance with various aspects of the present disclosure.

FIG. 10 is a flowchart of a method of wireless communication, in accordance with various aspects of the present disclosure.

FIG. 11 is a diagram illustrating an example of a hardware implementation for an example apparatus and/or network entity.

FIG. 12 is a diagram illustrating an example of a hardware implementation for an example network entity.

FIG. 13 is a diagram illustrating an example of a hardware implementation for an example network entity.

### DETAILED DESCRIPTION

Wireless communication networks, such as a 5G NR network, may enable positioning measurements and operations for wireless devices. For instance, a wireless communication network and/or a wireless device may utilize measurements associated with specific signaling to enable the determination of one or more angles of arrival, power levels of transmitted/received signals such as reference signal received power (RSRP), line of sight/non-line of sight information, etc., utilized for positioning operations in a positioning session. As one example, a network node, such as a base station, may provide DL signaling for a wireless device, such as a UE, which may respond with corresponding UL signaling from which the one or more angles of arrival, power levels of transmitted/received signals such as RSRP, line of sight/non-line of sight information, etc., may be determined. Based on the received signaling, the network node, or a network entity, such as a location management function (LMF), may perform operations to determine positioning of the wireless device.

However, scenarios may arise in which such signaling may not be adequate to determine accurate positioning for the wireless device. For instance, a network node may communicate/exchange communications/signaling with a wireless device via another wireless device such as a repeater. A repeater (e.g., a network-controlled repeater (NCR)) may be used to receive/forward positioning references for positioning of a wireless device. In some cases, such a repeater may forward DL/UL signaling between a network node and a wireless device (e.g., with no or minimal processing), and the network node is thus the logical source/destination of DL/UL signaling with respect to the wireless device. Yet, the positioning and transmission characteristics of the repeater, e.g., for transmission power levels, should be considered as the repeater is the physical source/destination for positioning purposes, in such scenarios.

Various aspects relate generally to positioning systems. Some aspects more specifically relate to UL-based positioning via a repeater. In some examples, a wireless device may be configured to obtain a SRS configuration for a UE, where the SRS configuration includes information associated with positioning of the UE. The wireless device may also be configured to perform at least one positioning measurement based on an UL transmission from the UE and the information associated with the positioning of the UE. The wireless device may also be configured to transmit, for a network node, an indication of the at least one positioning measurement. In some examples, a network node may be configured to receive, from a UE via a wireless device, a set of SRSs. The network node may also be configured to obtain, based on the set of SRSs, an indication of at least one E2E measurement associated with communications for the UE. The network node may be further configured to transmit, for a network entity, measurement information, where the measurement information includes the at least one E2E measurement associated with the communications for the UE.

Particular aspects of the subject matter described in this disclosure can be implemented to realize one or more of the following potential advantages. In some examples, by providing new signaling and procedures for positioning sessions in configurations that utilize repeaters in between wireless devices and network nodes, the described techniques can be used to enable UL-based positioning via a repeater. In some examples, by providing a repeater with UE-configured information, the described techniques can be used to determine positioning of wireless devices by repeaters. In some examples, by considering the one or more angles of arrival, power levels of transmitted/received signals such as RSRP, line of sight/non-line of sight information, signaling at, and/or positioning of, a repeater and providing such information from the repeater to a network node via UL signaling when performing a positioning session, the described techniques can be used to more accurately determine positioning of wireless devices that communicate via repeaters. Additionally, a network node and/or a network entity may be enabled to be aware of the position-related signaling from a wireless device via a repeater, and more accurate positioning for the wireless device may be determined. In some examples, by measuring E2E measurements for UE position-related signaling via a repeater, the described techniques can be used to provide the E2E measurements from a network node (e.g., a base station) to a network entity (e.g., a LMF) for positioning calculations/determinations in positioning sessions.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution. Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (CNB), NR BS. 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUS)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

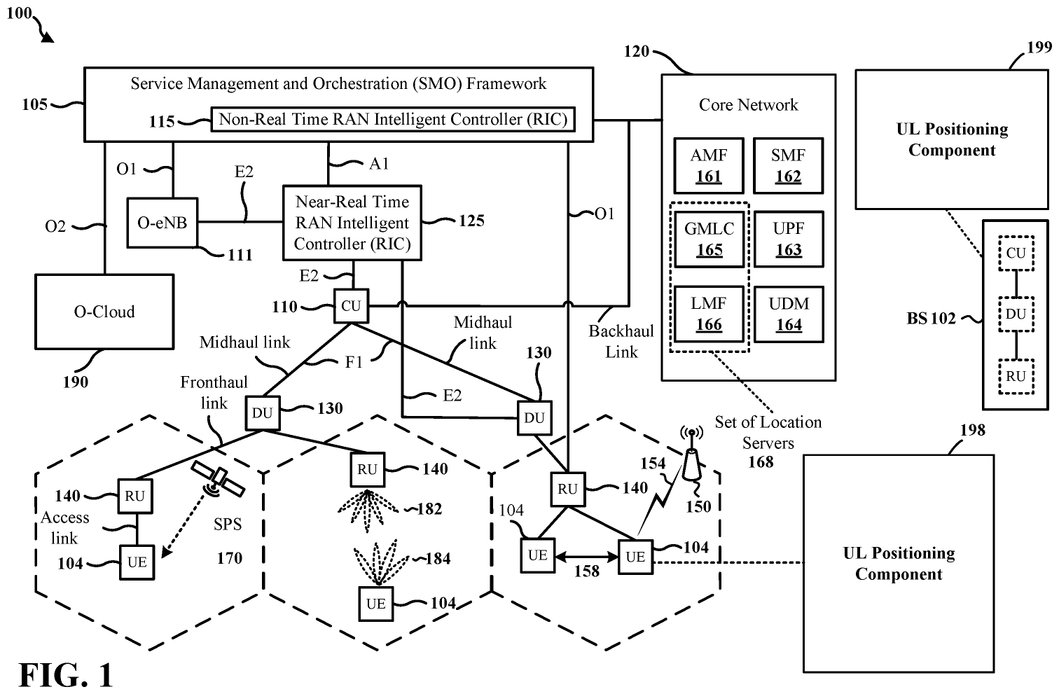

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHZ-7.125 GHZ) and FR2 (24.25 GHZ-52.6 GHZ). Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHZ. For example, three higher operating bands have been identified as frequency range designations FR2-2 (52.6 GHZ-71 GHZ), FR4 (71 GHZ-114.25 GHZ), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, cNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have an UL positioning component 198 (“component 198”) that may be configured to obtain a SRS configuration for a UE, the SRS configuration including information associated with positioning of the UE. The component 198 may also be configured to perform at least one positioning measurement based on an UL transmission from the UE and the information associated with the positioning of the UE. The component 198 may be further configured to transmit, for a network node, an indication of the at least one positioning measurement. The component 198 may be configured to transmit, for the network node, a frequency indication that indicates at least one frequency associated with at least one of the one or more signaling metrics. The component 198 may be configured to transmit, for the network node, a support indication that indicates at least one of an accuracy, a processing latency, a maximum number of supported measurements, a first indication of support for at least one of periodic measurements or aperiodic measurements, a second indication of support for at least one of periodic measurement reports or aperiodic measurement reports, a number of paths supported for measurements per SRS associated with at least one of the one or more signaling metrics, or at least one of the one or more signaling metrics that are supported by the wireless device. The component 198 may be configured to receive, from the network node, a side control configuration, where the side control configuration indicates at least one of a timing adjustment associated with receive-forward timing of a set of SRSs or a configured gain associated with transmission of the set of SRSs. In certain aspects, the base station 102 may have an UL positioning component 199 that may be configured to receive, from a UE via a wireless device, a set of SRSs. The component 199 may also be configured to obtain, based on the set of SRSs, an indication of at least one E2E measurement associated with communications for the UE. The component 199 may be further configured to transmit, for a network entity, measurement information, where the measurement information includes the at least one E2E measurement associated with the communications for the UE. The component 199 may be further configured to transmit, for the wireless device, a side control configuration, where the side control configuration indicates at least one of a timing adjustment associated with receive-forward timing of the set of SRSs or a configured gain associated with transmission of the set of SRSs. The component 199 may be further configured to measure a value of the SRS RSRP based on an E2E RSRP, an amplification gain, and a backhaul pathloss associated with the set of SRSs, where the measurement information includes the value of the SRS RSRP. The component 199 may be further configured to receive, from the network entity, a donor indication that indicates at least one of the first identifier of the wireless device or the second identifier of the network node. The component 199 may be further configured to receive, from a second network node, an activation for obtaining the at least one E2E measurement associated with communications for the UE. The component 199 may be further configured to receive, from the wireless device, an indication of at least one positioning measurement, where the at least one positioning measurement is based on an uplink (UL) transmission from the UE and the information associated with the positioning of the UE, where the at least one E2E measurement is associated with the at least one positioning measurement. The described aspects provide new signaling and procedures for positioning sessions in configurations that utilize repeaters in between wireless devices and network nodes, and enable UL-based positioning via a repeater. The described aspects also provide a repeater with UE-configured information, that may be used to determine positioning of wireless devices by repeaters. In some examples, by considering the one or more angles of arrival, power levels of transmitted/received signals such as RSRP, line of sight/non-line of sight information, signaling at, and/or positioning of, a repeater and providing such information from the repeater to a network node via UL signaling when performing a positioning session, more accurate determinations for positioning of wireless devices that communicate via repeaters are enabled. Additionally, a network node and/or a network entity are enabled through the described aspects to be aware of the position-related signaling from a wireless device via a repeater, and more accurate positioning for the wireless device may be determined. Aspects also provide the E2E measurements from a network node (e.g., a base station) to a network entity (e.g., a LMF) for positioning calculations/determinations in positioning sessions by measuring at a network node E2E measurements for UE position-related signaling via a repeater.

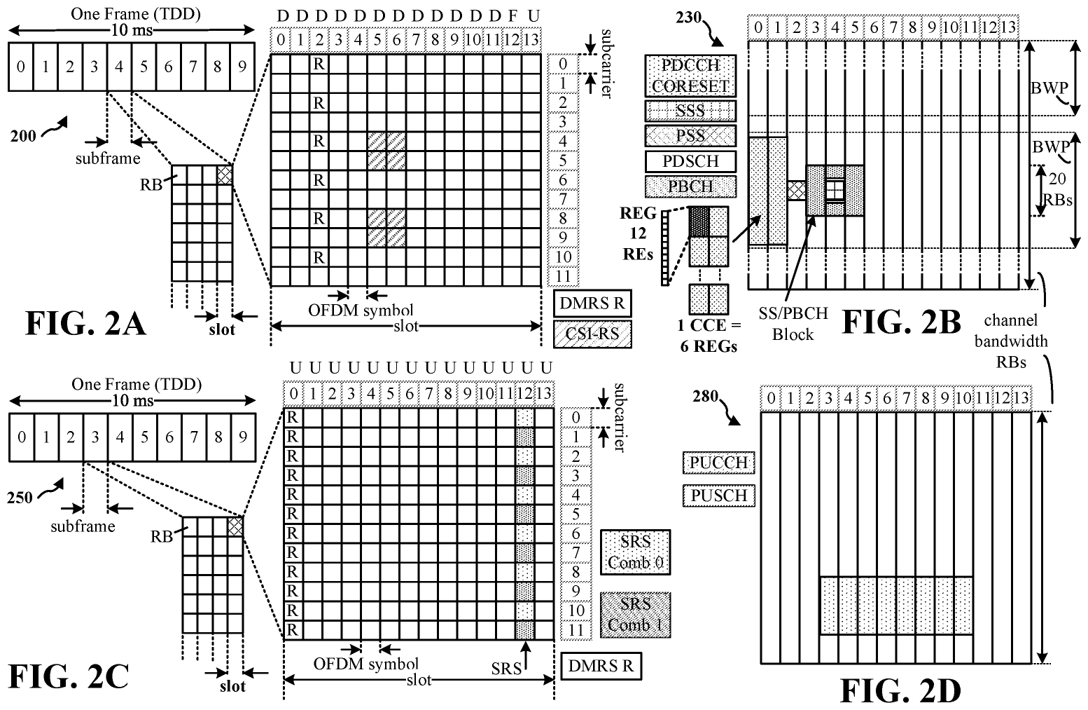

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 24 slots/subframe. The subcarrier spacing may be equal to 2^{μ}*15 kHz, where u is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

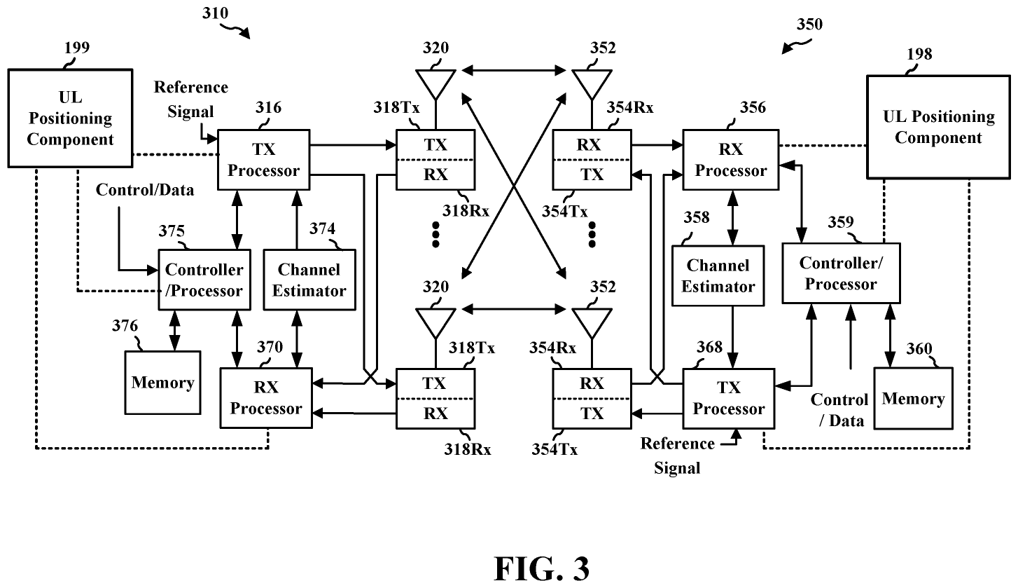

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the component 198 of FIG. 1. At least one of the TX processor 316, the RX processor 370, and the controller/processor 375 may be configured to perform aspects in connection with the component 199 of FIG. 1.

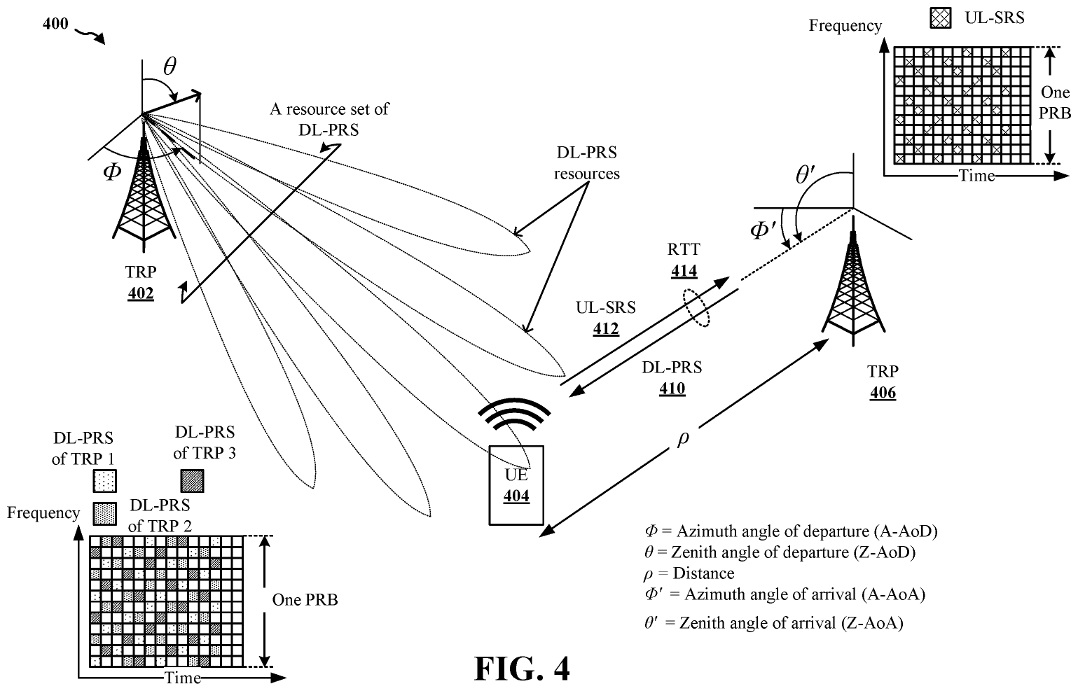

FIG. 4 is a diagram 400 illustrating an example of a UE positioning based on reference signal measurements. The UE 404 may transmit UL-SRS 412 at time T_{SRS_TX} and receive DL positioning reference signals (PRS) (DL-PRS) 410 at time T_{PRS_RX}. The TRP 406 may receive the UL-SRS 412 at time T_{SRS_RX} and transmit the DL-PRS 410 at time T_{PRS_TX}. The UE 404 may receive the DL-PRS 410 before transmitting the UL-SRS 412, or may transmit the UL-SRS 412 before receiving the DL-PRS 410. In both cases, a positioning server (e.g., location server(s)168) or the UE 404 may determine the RTT 414 based on ∥T_{SRS_RX}−T_{PRS_TX}|−|T_{SRS_TX}−T_{PRS_RX}∥. Accordingly, multi-RTT positioning may make use of the UE Rx-Tx time difference measurements (i.e., |T_{SRS_TX}−T_{PRS_RX}|) and DL-PRS reference signal received power (RSRP) (DL-PRS-RSRP) of downlink signals received from multiple TRPs 402, 406 and measured by the UE 404, and the measured TRP Rx-Tx time difference measurements (i.e., |T_{SRS_RX}−T_{PRS_TX}|) and UL-SRS-RSRP at multiple TRPs 402, 406 of uplink signals transmitted from UE 404. The UE 404 measures the UE Rx-Tx time difference measurements (and optionally DL-PRS-RSRP of the received signals) using assistance data received from the positioning server, and the TRPs 402, 406 measure the gNB Rx-Tx time difference measurements (and optionally UL-SRS-RSRP of the received signals) using assistance data received from the positioning server. The measurements may be used at the positioning server or the UE 404 to determine the RTT, which is used to estimate the location of the UE 404. Other methods are possible for determining the RTT, such as for example using DL-TDOA and/or UL-TDOA measurements.

DL-AoD positioning may make use of the measured DL-PRS-RSRP of downlink signals received from multiple TRPs 402, 406 at the UE 404. The UE 404 measures the DL-PRS-RSRP of the received signals using assistance data received from the positioning server, and the resulting measurements are used along with the azimuth angle of departure (A-AoD), the zenith angle of departure (Z-AoD), and other configuration information to locate the UE 404 in relation to the neighboring TRPs 402, 406.

DL-TDOA positioning may make use of the DL reference signal time difference (RSTD) (and optionally DL-PRS-RSRP) of downlink signals received from multiple TRPs 402, 406 at the UE 404. The UE 404 measures the DL RSTD (and optionally DL-PRS-RSRP) of the received signals using assistance data received from the positioning server, and the resulting measurements are used along with other configuration information to locate the UE 404 in relation to the neighboring TRPs 402, 406.

UL-TDOA positioning may make use of the UL relative time of arrival (RTOA) (and optionally UL-SRS-RSRP) at multiple TRPs 402, 406 of uplink signals transmitted from UE 404. The TRPs 402, 406 measure the UL-RTOA (and optionally UL-SRS-RSRP) of the received signals using assistance data received from the positioning server, and the resulting measurements are used along with other configuration information to estimate the location of the UE 404.

UL-AoA positioning may make use of the measured azimuth angle of arrival (A-AoA) and zenith angle of arrival (Z-AoA) at multiple TRPs 402, 406 of uplink signals transmitted from the UE 404. The TRPs 402, 406 measure the A-AoA and the Z-AoA of the received signals using assistance data received from the positioning server, and the resulting measurements are used along with other configuration information to estimate the location of the UE 404.

Additional positioning methods may be used for estimating the location of the UE 404, such as for example, UE-side UL-AoD and/or DL-AoA. Note that data/measurements from various technologies may be combined in various ways to increase accuracy, to determine and/or to enhance certainty, to supplement/complement measurements, and/or to substitute/provide for missing information.

For purposes of the present disclosure, a positioning session may be referred to the transmitting, the receiving, and the measuring of reference signals for the purposes of determining a positioning result or state (e.g., a location, a heading, a velocity, etc.) of a target entity. A target entity may be any object (e.g., a person, a vehicle, wireless device such as a UE, etc.) for which a positioning session is performed, for example, to determine a location thereof, a velocity thereof, a heading thereof, etc.

A wireless communication network and/or a wireless device may utilize measurements associated with specific signaling to enable the determination of one or more angles of arrival, power levels of transmitted/received signals such as RSRP, line of sight/non-line of sight information, etc., utilized for positioning operations in a positioning session. As one example, a network node, such as a base station, may provide DL signaling for a wireless device, such as a UE, which may respond with corresponding UL signaling from which the one or more angles of arrival, power levels of transmitted/received signals such as RSRP, line of sight/non-line of sight information, etc., may be determined. Based on the received signaling, the network node, or a network entity, such as a LMF, may perform operations to determine positioning of the wireless device. However, scenarios may arise in which such signaling may not be adequate to determine accurate positioning for the wireless device. For instance, a network node may communicate/exchange communications/signaling with a wireless device via another wireless device such as a repeater. A repeater (e.g., a NCR) may be used to receive/forward positioning references for positioning of a wireless device. In some cases, such a repeater may forward DL/UL signaling between a network node and a wireless device (e.g., with no or minimal processing), and the network node is thus the logical source/destination of DL/UL signaling with respect to the wireless device. Yet, the positioning and transmission characteristics of the repeater, e.g., for transmission power levels, should be considered as the repeater is the physical source/destination for positioning purposes, in such scenarios.

Aspects described herein for UL-based positioning via a repeater improve positioning sessions and positioning determinations for wireless devices that communication through repeaters. In some examples, a wireless device may be configured to obtain a SRS configuration for a UE, where the SRS configuration includes information associated with positioning of the UE. The wireless device may also be configured to perform at least one positioning measurement based on an UL transmission from the UE and the information associated with the positioning of the UE. The wireless device may also be configured to transmit, for a network node, an indication of the at least one positioning measurement. In some examples, a network node may be configured to receive, from a UE via a wireless device, a set of SRSs. The network node may also be configured to obtain, based on the set of SRSs, an indication of at least one E2E measurement associated with communications for the UE. The network node may be further configured to transmit, for a network entity, measurement information, where the measurement information includes the at least one E2E measurement associated with the communications for the UE. The described aspects provide new signaling and procedures for positioning sessions in configurations that utilize repeaters in between wireless devices and network nodes, and enable UL-based positioning via a repeater. The described aspects also provide a repeater with UE-configured information, that may be used to determine positioning of wireless devices by repeaters. In some examples, by considering the one or more angles of arrival, power levels of transmitted/received signals such as RSRP, line of sight/non-line of sight information, signaling at, and/or positioning of, a repeater and providing such information from the repeater to a network node via UL signaling when performing a positioning session, more accurate determinations for positioning of wireless devices that communicate via repeaters are enabled. Additionally, a network node and/or a network entity are enabled through the described aspects to be aware of the position-related signaling from a wireless device via a repeater, and more accurate positioning for the wireless device may be determined. In some examples, by measuring E2E measurements for UE position-related signaling via a repeater, the described techniques can be used to provide the E2E measurements from a network node (e.g., a base station) to a network entity (e.g., a LMF) for positioning calculations/determinations in positioning sessions. In aspects, new signaling and procedures are provided to enable UL-based positioning via a repeater. For example, new signaling may share a SRS configuration of a UE with a repeater, and the repeater may be enabled to provide measurement results. In some aspects, the repeater may forward a SRS to a network node (e.g., a gNB) to make measurements on behalf of the repeater.

While various aspects may be described in the context of positioning for descriptive and illustrative purposes, aspects are not so limited and the information exchange via signaling and measurements herein may be applicable to other types of resources and operations, with or without repeaters in communication/signaling paths, as would be understood by persons of skill in the relevant art(s) having the benefit of this disclosure. As one example, a repeater may be provided with an SRS configuration and may perform measurements for any type of metrics, specific to positioning and/or specific to any other operations, such as, but without limitation, RF sensing, beam management, mobility, handovers, and/or the like.

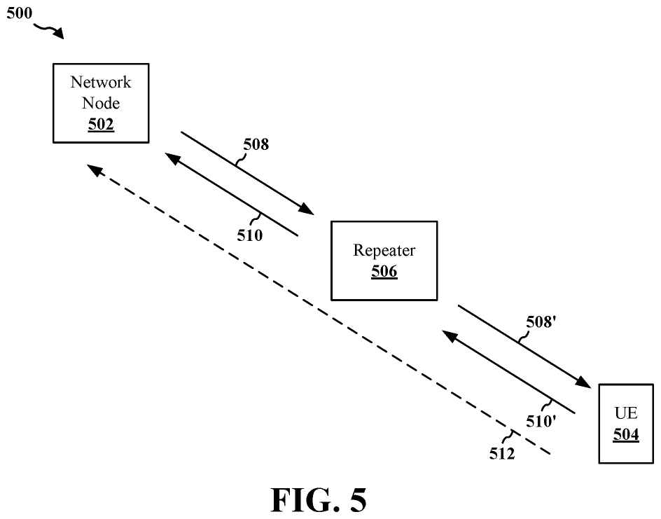

FIG. 5 is a diagram 500 illustrating a repeater 506 in various aspects. As shown in FIG. 5, the repeater 506 may receive DL signals 508 from a network node 502 and forward the DL signals (shown as signals 508′) to a wireless device, e.g., a remote UE 504. Similarly, the repeater 506 may receive UL signals 510 from the remote UE 504 and forward the UL signals (shown as signals 510′) to the network node 502. While the repeater 506 may forward the DL signal 508 and/or the UL signal 510 (e.g., with no or minimal processing), the network node 502 (e.g., a base station) may be the logical or originating source/destination of DL/UL signaling, respectively, the repeater 506 may be considered as the physical source/destination for positioning purposes.

For instance, the angles of arrival, line of sight/non-line of sight information, power levels (e.g., RSRP) of the UL signal 510′ provided by the remote UE 504 and received at the repeater 506 may differ from the UL signal 510 and/or from an UL signal 512 provided by the remote UE 504 and received at the network node 502 without the repeater 506. As an example, the angles of arrival, line of sight/non-line of sight information, power levels (e.g., RSRP) of the UL signal 510′ received from the remote UE 504 by the repeater 506 may vary from the UL signal 510 transmitted from the repeater 506 to the network node 502 and/or from an UL signal 512 provided by the remote UE 504 and received at the network node 502 without the repeater 506 due to positioning of the repeater 506, gain configurations/capabilities of the repeater 506, backhaul channel pathloss, etc.

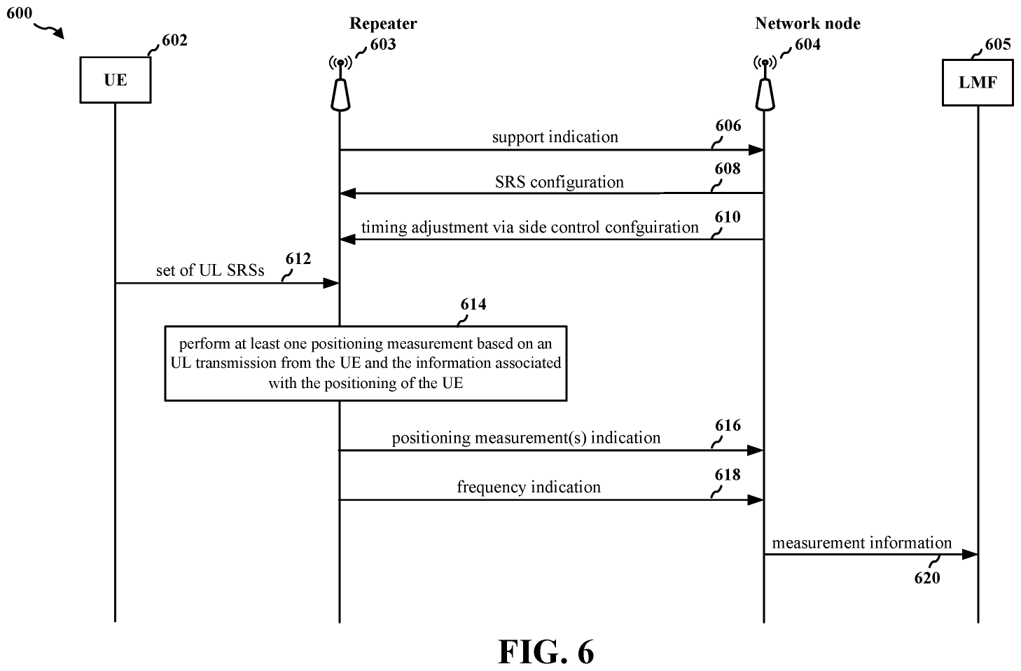

FIG. 6 is a call flow diagram 600 for wireless communications, in various aspects. Call flow diagram 600 illustrates UL-based positioning via a repeater (e.g., a repeater 603, such as a NCR) that may communicate with a wireless device (e.g., a UE 602, such as a remote UE, etc.), a network node (e.g., a network node 604, such as a base station, a gNB, or other type of base station or network node, etc.), and/or a LMF (e.g., a LMF 605), by way of example, as shown, in the performance of positioning operations/sessions. Aspects described for the network node 604 may be performed by the network node 604 in aggregated form and/or by one or more components of the network node 604 in disaggregated form. Additionally, or alternatively, the aspects may be performed by the UE 602, the repeater 603, and/or the LMF 605, autonomously, in addition to, and/or in lieu of, operations of the network node 604. In aspects, the repeater 603 may include one or more of a NCR mobile termination unit (NCR-MT) or a NCR forwarding node (NCR-FW), each of which may perform described aspects together or separately.

In the illustrated aspect, the repeater 603 may be configured to provide/transmit a support indication 606 to network node 604. In aspects, the support indication 606 may indicate at least one of an accuracy, a processing latency, a maximum number of supported measurements, a first indication of support for at least one of periodic measurements or aperiodic measurements, a second indication of support for at least one of periodic measurement reports or aperiodic measurement reports, a number of paths supported for measurements per SRS associated with at least one of the one or more signaling metrics, or at least one of one or more signaling metrics that are supported by the repeater 603. In aspects, a signaling metric may be states of a device that are associated with its positioning. In some aspects, the repeater 603 may be configured to measure/perform a positioning measurement(s) (e.g., a measurement associated with positioning of a wireless device such as a UE) for signaling received from the UE 602. The positioning measurement(s) may include one or more signaling metrics, including but without limitation, at least one of an UL angle of arrival (AoA), a zenith AoA (Z-AoA), a time of arrival (ToA), a relative ToA (RToA), an SRS received power (RSRP), a reception-transmission (RxTx) time difference of the network node, an SRS received path power (RSRPP), a time stamp, a measurement quality, a quasi-co-location (QCL) of a beam associated with the UL transmission, an SRS resource type, an SRS resource identifier, an antenna reference point (ARP) identifier, a line of sight (LoS) indication, or a non-line of sight (NLoS) indication. The support indication 606 may also indicate support of the repeater 603 to perform one or more of such signaling metrics. In aspects, the one or more signaling metrics may include at least one soft signaling metric that is based on an estimation associated with the UL transmission (e.g., a set of SRSs, described below).

The repeater 603 may be configured to obtain a SRS configuration 608 for a UE (e.g., the UE 602. In aspects, the SRS configuration 608 may include information associated with positioning of the UE 602. The network node 604 may be configured to provide/transmit the SRS configuration 608 to the repeater 603. In aspects, the SRS configuration 608 for the UE 602 may be received by the repeater 603, from the network node 604, via RRC signaling, a medium access control (MAC) control element (MAC-CE), or DCI. The transmission of the SRS configuration 608 may be based on at least one of an F1 access protocol (F1AP) signaling information element (IE) or a new radio positioning protocol A (NRPPa) signaling IE. In aspects, the SRS configuration 608 may be based on the support indication 606. The repeater 603 may thus be configured to receive UL signals (e.g., SRSs) from the UE 602 and perform positioning measurements for one or more of the signaling metrics that are supported by the repeater 603. In some aspects, the repeater 603 may thus be configured to receive UL signals (e.g., SRSs) from the UE 602 and forward the received UL signals to the network node 604, as described herein.

In aspects, the repeater 603 may be configured to receive, from the network node 604, a timing adjustment 610, via aside control configuration. The side control configuration may indicate the timing adjustment 610, which may be associated with receive-forward (RX/FWD) timing of a set of SRSs 612 (e.g., one or more UL SRSs), and/or a configured gain associated with transmission of the set of SRSs 612. For instance, in legacy side control, an NCR, e.g., the repeater 603, may be configured to forward an UL SRS(s), e.g., the set of SRSs 612, to a DU (e.g., as a part of the network node 604). A RX/FWD timing reference may be different than the normal operation(s) (e.g., when forwarding a SRS from non-serving UEs), and therefore, aspects enable support of side control to adjust the RX/FWD timing. For transmit (TX) power/amplification gain, a same gain may be utilized for various access beams by which SRSs are transmitted, and aspects enable provision of indications for a configured gain associated with transmission of the set of SRSs 612, such that if the same gain is not utilized for various access beams, the “delta” or difference(s) between the beam gains may be known, indicated, compensated for, and/or the like.

The repeater 603 may be configured to receive, and the UE 602 may be configured to provide/transmit, the set of UL SRSs 612. As noted above, the repeater 603 may be provided through the SRS configuration 608 for the UE 602 via new signaling, according to aspects, with the characteristics of SRS signaling by the UE 602. Accordingly, aspects herein enable a repeater to perform SRS positioning measurements based on an UL transmission (e.g., a set of SRSs) from a UE. The repeater 603 may be configured to perform (at 614) at least one SRS positioning measurement based on the set of SRSs 612 from the UE 602 and the information in the set of SRSs 612 that is associated with the positioning of the UE 602.

The repeater 603 may be configured to provide/transmit, for the network node 604, an indication 616 of the at least one positioning measurement obtained (at 614). In aspects, the repeater 603 may be configured to provide/transmit, and the network node 604 may be configured to receive, the indication 616 of the at least one positioning measurement, obtained (at 614), via RRC signaling, a MAC-CE, or DCI, e.g., via a UE-to-UTRAN (Uu) interface. The transmission of the SRS configuration 608 may be based on at least one of an F1AP signaling IE or a NRPPa signaling IE. The repeater 603 may be configured to provide/transmit, for the network node 604, a frequency indication 618. The frequency indication 618 may indicate at least one frequency associated with at least one of the one or more signaling metrics, described above.

The network node 604 may be configured to provide/transmit measurement information 620, and the LMF 605 may be configured to receive the measurement information 620. In aspects, the measurement information 620 may be based on the indication 616 of the positioning measurement(s) and/or on the frequency indication 618. The LMF 605 may thus be enabled to perform positioning operations associated with the UE 602 based on the measurement information 620.

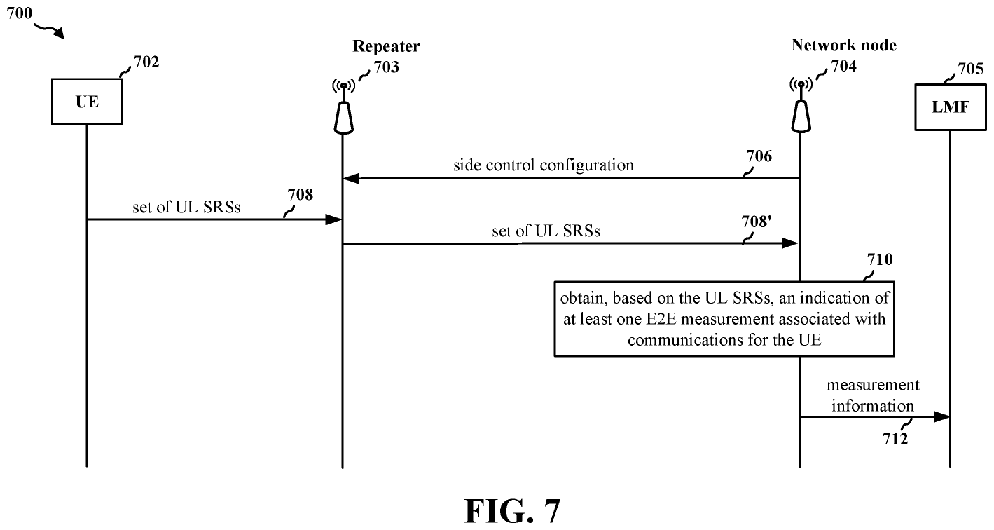

FIG. 7 is a call flow diagram 700 for wireless communications, in various aspects. Call flow diagram 700 illustrates UL-based positioning via a repeater (e.g., a repeater 703, such as a NCR) that may communicate with a wireless device (e.g., a UE 702, such as a remote UE, etc.), a network node (e.g., a network node 704, such as a base station, a gNB, or other type of base station or network node, etc.), and/or a LMF (e.g., a LMF 705), by way of example, as shown, in the performance of positioning operations/sessions. Aspects described for the network node 704 may be performed by the network node 704 in aggregated form and/or by one or more components of the network node 704 in disaggregated form. Additionally, or alternatively, the aspects may be performed by the UE 702, the repeater 703, and/or the LMF 705, autonomously, in addition to, and/or in lieu of, operations of the network node 704. In aspects, the repeater 703 may include one or more of a NCR-MT or a NCR-FW, each of which may perform described aspects together or separately.

In the illustrated aspect, the network node 704 may be configured to transmit/provide, and the repeater 703 may be configured to receive, a timing adjustment 706, via a side control configuration. The side control configuration may indicate the timing adjustment 706, which may be associated with receive-forward (RX/FWD) timing of a set of SRSs 708 (e.g., one or more UL SRSs), and/or a configured gain associated with transmission of the set of SRSs 708. For instance, in legacy side control, an NCR, e.g., the repeater 703, may be configured to forward an UL SRS(s), e.g., the set of SRSs 708, to a DU (e.g., as a part of the network node 704). A RX/FWD timing reference may be different than the normal operation(s) (e.g., when forwarding a SRS from non-serving UEs), and therefore, aspects enable support of side control to adjust the RX/FWD timing. For transmit (TX) power/amplification gain, a same gain may be utilized for various access beams by which SRSs are transmitted, and aspects enable provision of indications for a configured gain associated with transmission of the set of SRSs 708, such that if the same gain is not utilized for various access beams, the “delta” or difference(s) between the beam gains may be known, indicated, compensated for, and/or the like. The repeater 703 may be configured to receive, and the UE 702 may be configured to provide/transmit, the set of UL SRSs 708.

As noted herein, a repeater such as the repeater 703 may be provided through an SRS configuration (e.g., the SRS configuration 608 for the UE 602 via new signaling, according to aspects, in FIG. 6, not shown here for clarity of illustration) with the characteristics of UE SRS signaling. Additionally, while not described/shown here for brevity and clarity of illustration, the repeater 703 may be configured, in aspects to perform at least one positioning measurement based on the set of SRSs 708 from the UE 702 and the information associated with the positioning of the UE 702, and the network node 704 may be configured to receive, from the wireless repeater 703, an indication of at least one positioning measurement (as similarly described above with respect to FIG. 6), where the at least one positioning measurement is based on an uplink (UL) transmission from the UE (e.g., the set of SRSs 708 from the UE 702) and the information associated with the positioning of the UE 702 in the set of SRSs 708, and where the at least one E2E measurement is associated with the at least one positioning measurement. In aspects, the indication of at least one positioning measurement may be provided to the network node 704 via RRC signaling, a MAC-CE, or DCI, which may be based on at least one of an F1AP signaling IE or a NRPPa signaling IE.

In some aspects, where the repeater 703 may not be configured to perform (e.g., as shown at 614 in FIG. 6) at least one SRS positioning measurement based on the set of SRSs 708 from the UE 702 and the information in the set of SRSs 708 that is associated with the positioning of the UE 702, the repeater 703 may be configured to forward/transmit/provide, and the network node 704 may be configured to receive, the set of SRSs 708 to the network node 704 as a forwarded set of SRSs 708′. In other words, and the network node may be configured to receive, from the UE 702 via the repeater 703 (e.g., a wireless device or a TRP), the set of SRSs 708 as the set of forwarded SRSs 708′.

In some aspects, the forwarded set of SRSs 708′ may be received by the network node 704 based on at least one of the timing adjustment 706 associated with the receive-forward timing of the forwarded set of SRSs 708′ or the configured gain associated with the transmission of the forwarded set of SRSs 708′, e.g., based on the side control configuration. In some aspects, the forwarded set of SRSs 708′ may be received by the network node 704 with a transmitted gain that is different from the configured gain associated with the transmission of the set of SRSs 708. In such aspects, the received gain difference information may indicate a difference or ‘delta’ between the transmitted gain of the set of SRSs 708 and the configured gain associated with the transmission of the forwarded set of SRSs 708′. In some aspects, the forwarded set of SRSs 708′ may be received via at least one beam of the repeater 703 (e.g., as illustrated for the TRP 402 in FIG. 4). In some aspects, the network node 704 may be configured to receive, from the LMF 705, a donor indication that indicates a first identifier of the repeater 703 and/or a second identifier of the network node 704. In such aspects, the forwarded set of SRSs 708′ may be received based on the donor indication (e.g., based on the first identifier of the repeater 703 and/or the second identifier of the network node 704).

The network node 704 may be configured to obtain (at 710), based on the forwarded set of SRSs 708′, an indication of at least one E2E measurement associated with communications for the UE 702. For instance, aspects herein provide that a repeater (e.g., the repeater 703) may forward UL SRSs (e.g., the forwarded set of SRSs 708′) to a network node (e.g., the network node 704, such as a gNB with a DU) and the network node may be configured to make positioning measurements on behalf of the repeater. As noted herein, signaling metrics may include, without limitation, at least one of an UL AoA, a Z-AoA, a ToA, a RToA, an SRS RSRP, a RxTx time difference of the network node, an SRS received path power (RSRPP), a time stamp, a measurement quality, a quasi-co-location (QCL) of a beam associated with the UL transmission, an SRS resource type, an SRS resource identifier, an antenna reference point (ARP) identifier, a line of sight (LoS) indication, or a non-line of sight (NLoS) indication. In aspects, the network node 704 (e.g., via a DU thereof) may be configured to calculate as part of the obtaining (at 710), angular information, including without limitation, an AoA, a Z-AoA, etc., when the network node 704 has a requisite amount of spatial direction information of the repeater 703. In such aspects, the network node 704 may map access beams of the repeater 703 to the angles. In aspects, the network node 704 may have information, including but not limited to, information associated with the amplification gain of the repeater 703, backhaul pathloss, and/or the like (e.g., where the SRS-RSRP may be equal to, or approximately equal to: E2E RSRP-(amplification gain-backhaul pathloss)). For example, in aspects, the network node 704 may be configured to measure a value of the SRS RSRP based on the E2E RSRP, the amplification gain of the repeater 703, and the backhaul pathloss associated with the forwarded set of SRSs 708′, and the value of the SRS RSRP may be included the measurement information 712. In aspects, the E2E measurement associated with the communications for the UE 702 may include the E2E RSRP. Likewise, the network node 704 may calculate/determine other signaling metrics, based on the forwarded set of SRSs 708′, information associated therewith, and/or the indication of at least one E2E measurement associated with communications for the UE 702, as obtained (at 710). In aspects, the network node 704 may be configured to calculate signaling metrics associated with timing (e.g., the RTOA, the RxTx time difference of the network node, etc., based on information associated with the backhaul channel propagation delay and the internal delay associated with the repeater 703. When the network node 704 has the requisite amount of information, calculated/derived (at 710) positioning measurements and/or signaling metrics obtained by the network node 704 for the repeater 703 may be provided by the network node 704 to the LMF 705 as measurement information 712. In some aspects, the measurement information obtained (at 710) may include at least one of an angle associated with the at least one beam or an identifier of the at least one beam of the repeater 703 (e.g., as illustrated for the TRP 402 in FIG. 4). In some aspects, the measurement information may include a first identifier of the wireless device and/or a second identifier of the network node.

If the network node 704 (e.g., via a DU thereof) does not have a requisite amount of information to determine/calculate (at 710) positioning measurements based on the forwarded set of SRSs 708′, information associated therewith, and/or the indication of the E2E measurement, the network node 704 may indicate to the LMF 705 at least the indication of the E2E measurement, and any other information determined (e.g., the identity of a beam(s) of the repeater 703 used to detect/measure the set of SRSs 708, as described above, in the measurement information 712. In aspects, the LMF 705 may be configured to derive/calculate angular information for the UE 702 based on the measurement information 712. metric.

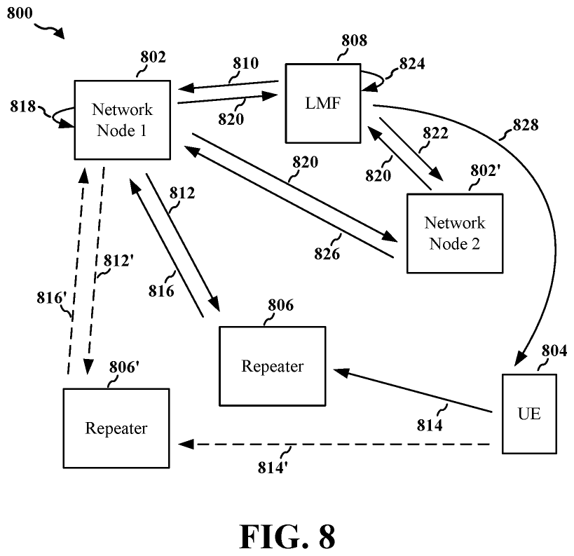

FIG. 8 is a diagram 800 illustrating an example of UL-based positioning measurements via a repeater, in various aspects. Diagram 800 may be a further aspect of the call flow diagram 700 in FIG. 7. Diagram 800 shows a network node 802, a UE 804, and a repeater 806.

In aspects, the LMF 808 may be configured to provide/transmit a donor indication 810 that indicates at least one of the first identifier of the repeater 806 or the second identifier of the network node 802. The donor indication 810 may indicate at least one TRP (e.g., the repeater 806 and/or the network node 802) that is associated with an E2E measurement (e.g., for SRS signaling by the UE 804). The network node 802 may provide signaling 812 (e.g., a SRS configuration, a timing adjustment via a side control configuration, etc.) to the repeater 806. The donor indication 810 may indicate that a set of SRSs 814 from the UE 804 are to be provided to the network node 802 via the repeater 806 as a forwarded set of SRSs 816, rather than indicating that the network node 802 is to provide signaling 812′ that a set of SRSs 814′ from the UE 804 are to be provided to the network node 802 via a repeater 806′ as a forwarded set of SRSs 816′. The repeater 806 may be configured to provide the forwarded set of SRSs 816 to the network node 802, which may be configured to calculate/derive (at 818) measurement information 820, including at least one E2E measurement, positioning measurements, signaling metrics, the timing adjustment, a donor identifier associated with the at least one TRP, at least one type indication respectively corresponding to at least one of the one or more measurement values, where each type indication indicates an E2E type or an adjusted type, a mapping of at least one access beam to at least one corresponding angle of arrival, and/or the like, as described herein, and to provide the positioning measurements and/or signaling metrics to the LMF 808.

In some aspects, the LMF 808 may be configured to transmit/provide an activation configuration 822 to a network node 802′. The network node 802 may be configured to receive, from a second network node 802′ and based on the activation configuration, an activation 826 that indicates the network node 802 to obtain the at least one E2E measurement associated with communications for the UE 804. In such aspects, the network node 802 may perform operations as described above for diagram 800 and transmit the measurement information 820, for the repeater 806, to the LMF 808 via the second network node 802′.

In some aspects, the LMF 808 may be configured to calculate/derive (at 824) positioning measurements and/or signaling metrics based on the measurement information 820 as a set of positioning metrics 828. In aspects, to obtain (e.g., calculate/derive (at 824)) the set of positioning metrics 828 for the UE 804 based on the measurement information 820, the LMF 808 may be configured to process the E2E measurement to obtain at least a first portion of the set of positioning metrics 828 for the UE 804 and/or include the at least one adjusted measurement as at least a second portion of the set of positioning metrics 828 for the UE 804. The LMF 808 may be configured to output the set of positioning metrics 828. In aspects, to output the set of positioning metrics 828, the LMF 808 may be configured to calculate/derive (at 824) the set of positioning metrics 828 and/or transmit/provide the set of positioning metrics 828 to the UE 804.

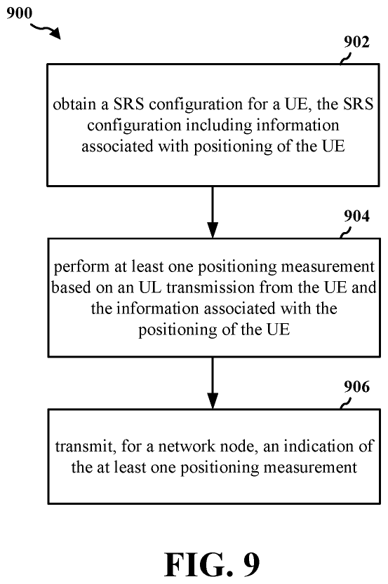

FIG. 9 is a flowchart 900 of a method of wireless communication, in various aspects. The method may be performed by a wireless device (e.g., the repeater 506, 603, 703, 806; the TRP 402, 406; the apparatus 1104). In some aspects, the method may include aspects described in connection with the communication flow in FIG. 6 and/or aspects described in FIGS. 7, 8. The method provides for UL-based positioning via a repeater that improve positioning sessions and positioning determinations for wireless devices via repeaters (e.g., NCRs).

At 902, a wireless device obtains a SRS configuration for a UE, the SRS configuration including information associated with positioning of the UE. As an example, the obtaining may be performed, at least in part, by the component 198. FIG. 6 may illustrate an example of a wireless device (e.g., the repeater 603) obtaining such a SRS configuration for a UE (e.g., the UE 602).

The repeater 603 may be configured to provide/transmit a support indication 606 to network node 604. In aspects, the support indication 606 may indicate at least one of an accuracy, a processing latency, a maximum number of supported measurements, a first indication of support for at least one of periodic measurements or aperiodic measurements, a second indication of support for at least one of periodic measurement reports or aperiodic measurement reports, a number of paths supported for measurements per SRS associated with at least one of the one or more signaling metrics, or at least one of one or more signaling metrics that are supported by the repeater 603. In some aspects, the repeater 603 may be configured to measure/perform a positioning measurement(s) for signaling received from the UE 602. The positioning measurement(s) may include one or more signaling metrics, including but without limitation, at least one of an UL angle of arrival (AoA), a zenith AoA (Z-AoA), a time of arrival (ToA), a relative ToA (RToA), an SRS received power (RSRP), a reception-transmission (RxTx) time difference of the network node, an SRS received path power (RSRPP), a time stamp, a measurement quality, a quasi-co-location (QCL) of a beam associated with the UL transmission, an SRS resource type, an SRS resource identifier, an antenna reference point (ARP) identifier, a line of sight (LoS) indication, or a non-line of sight (NLoS) indication. The support indication 606 may also indicate support of the repeater 603 to perform one or more of such signaling metrics. In aspects, the one or more signaling metrics may include at least one soft signaling metric that is based on an estimation associated with the UL transmission (e.g., a set of SRSs, described below).

The repeater 603 may be configured to obtain a SRS configuration 608 for a UE (e.g., the UE 602. In aspects, the SRS configuration 608 may include information associated with positioning of the UE 602. The network node 604 may be configured to provide/transmit the SRS configuration 608 to the repeater 603. In aspects, the SRS configuration 608 for the UE 602 may be received by the repeater 603, from the network node 604, via RRC signaling, a medium access control (MAC) control element (MAC-CE), or DCI. The transmission of the SRS configuration 608 may be based on at least one of an F1 access protocol (F1AP) signaling information element (IE) or a new radio positioning protocol A (NRPPa) signaling IE. In aspects, the SRS configuration 608 may be based on the support indication 606. The repeater 603 may thus be configured to receive UL signals (e.g., SRSs) from the UE 602 and perform positioning measurements for one or more of the signaling metrics that are supported by the repeater 603. In some aspects, the repeater 603 may thus be configured to receive UL signals (e.g., SRSs) from the UE 602 and forward the received UL signals to the network node 604, as described herein.

In aspects, the repeater 603 may be configured to receive, from the network node 604, a timing adjustment 610, via aside control configuration. The side control configuration may indicate the timing adjustment 610, which may be associated with receive-forward (RX/FWD) timing of a set of SRSs 612 (e.g., one or more UL SRSs), and/or a configured gain associated with transmission of the set of SRSs 612. For instance, in legacy side control, an NCR, e.g., the repeater 603, may be configured to forward an UL SRS(s), e.g., the set of SRSs 612, to a DU (e.g., as a part of the network node 604). A RX/FWD timing reference may be different than the normal operation(s) (e.g., when forwarding a SRS from non-serving UEs), and therefore, aspects enable support of side control to adjust the RX/FWD timing. For transmit (TX) power/amplification gain, a same gain may be utilized for various access beams by which SRSs are transmitted, and aspects enable provision of indications for a configured gain associated with transmission of the set of SRSs 612, such that if the same gain is not utilized for various access beams, the “delta” or difference(s) between the beam gains may be known, indicated, compensated for, and/or the like.

At 904, the wireless device performs at least one positioning measurement based on an UL transmission from the UE and the information associated with the positioning of the UE. As an example, the performance may be performed, at least in part, by the component 198. FIG. 6 may illustrate an example of a wireless device (e.g., the repeater 603) performing at least one positioning measurement.

The repeater 603 may be configured to receive, and the UE 602 may be configured to provide/transmit, the set of UL SRSs 612. As noted above, the repeater 603 may be provided through the SRS configuration 608 for the UE 602 via new signaling, according to aspects, with the characteristics of SRS signaling by the UE 602. Accordingly, aspects herein enable a repeater to perform SRS positioning measurements based on an UL transmission (e.g., a set of SRSs) from a UE. The repeater 603 may be configured to perform (at 614) at least one SRS positioning measurement based on the set of SRSs 612 from the UE 602 and the information in the set of SRSs 612 that is associated with the positioning of the UE 602.

At 906, the wireless device transmits, for a network node, an indication of the at least one positioning measurement. As an example, the transmission may be performed, at least in part, by the component 198. FIG. 6 may illustrate an example of a wireless device (e.g., the repeater 603) transmitting such an indication for a network node (e.g., the network node 604).

The repeater 603 may be configured to provide/transmit, for the network node 604, an indication 616 of the at least one positioning measurement obtained (at 614). In aspects, the repeater 603 may be configured to provide/transmit, and the network node 604 may be configured to receive, the indication 616 of the at least one positioning measurement, obtained (at 614), via RRC signaling, a MAC-CE, or DCI. The transmission of the SRS configuration 608 may be based on at least one of an F1AP signaling IE or a NRPPa signaling IE. The repeater 603 may be configured to provide/transmit, for the network node 604, a frequency indication 618. The frequency indication 618 may indicate at least one frequency associated with at least one of the one or more signaling metrics, described above.

The network node 604 may be configured to provide/transmit measurement information 620, and the LMF 605 may be configured to receive the measurement information 620. In aspects, the measurement information 620 may be based on the indication 616 of the positioning measurement(s) and/or on the frequency indication 618. The LMF 605 may thus be enabled to perform positioning operations associated with the UE 602 based on the measurement information 620.

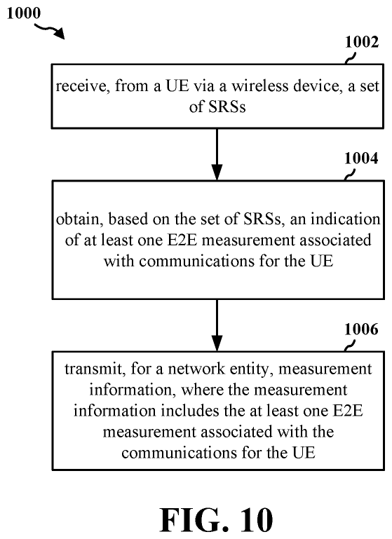

FIG. 10 is a flowchart 1000 of a method of wireless communication, in various aspects. The method may be performed by a network node (e.g., a base station such as the base station 102; the network node 502, 604, 704, 802; the network entity 1102, 1202, 1360). In some aspects, the method may include aspects described in connection with the communication flow in FIG. 7 and/or aspects described in FIGS. 6, 8. The method provides for UL-based positioning via a repeater that improve positioning sessions and positioning determinations for wireless devices via repeaters (e.g., NCRs).

At 1002, a network node receives, from a UE via a wireless device, a set of SRSs. As an example, the reception may be performed, at least in part, by the component 199. FIG. 7 may illustrate an example of a network node (e.g., the network node 704) receiving a set of SRSs via a repeater (e.g., a NCR such as the repeater 703).

In some aspects, where the repeater 703 (e.g., 806 in FIG. 8) may not be configured to perform (e.g., as shown at 614 in FIG. 6) at least one SRS positioning measurement based on the set of SRSs 708 (e.g., 814 in FIG. 8) from the UE 702 (e.g., 804 in FIG. 8) and the information in the set of SRSs 708 (e.g., 814 in FIG. 8) that is associated with the positioning of the UE 702 (e.g., 804 in FIG. 8), the repeater 703 (e.g., 806 in FIG. 8) may be configured to forward/transmit/provide, and the network node 704 may be configured to receive, the set of SRSs 708 (e.g., 814 in FIG. 8) to the network node 704 as a forwarded set of SRSs 708′ (e.g., 814′ in FIG. 8). In other words, and the network node may be configured to receive, from the UE 702 (e.g., 804 in FIG. 8) via the repeater 703 (e.g., 806 in FIG. 8) (e.g., a wireless device or a TRP), the set of SRSs 708 (e.g., 814 in FIG. 8) as the set of forwarded SRSs 708′ (e.g., 814′ in FIG. 8). In some aspects, the forwarded set of SRSs 708′ (e.g., 814′ in FIG. 8) may be received by the network node 704 based on at least one of the timing adjustment 706 (e.g., 812 in FIG. 8) associated with the receive-forward timing of the forwarded set of SRSs 708′ (e.g., 814′ in FIG. 8) or the configured gain associated with the transmission of the forwarded set of SRSs 708′ (e.g., 814′ in FIG. 8), e.g., based on the side control configuration. In some aspects, the forwarded set of SRSs 708′ (e.g., 814′ in FIG. 8) may be received by the network node 704 with a transmitted gain that is different from the configured gain associated with the transmission of the set of SRSs 708 (e.g., 814 in FIG. 8). In such aspects, the received gain difference information may indicate a difference or ‘delta’ between the transmitted gain of the set of SRSs 708 (e.g., 814 in FIG. 8) and the configured gain associated with the transmission of the forwarded set of SRSs 708′ (e.g., 814′ in FIG. 8). In some aspects, the forwarded set of SRSs 708′ (e.g., 814′ in FIG. 8) may be received via at least one beam of the repeater 703 (e.g., 806 in FIG. 8) (e.g., as illustrated for the TRP 402 in FIG. 4). In some aspects, the network node 704 may be configured to receive, from the LMF 705 (e.g., 808 in FIG. 8), a donor indication that indicates a first identifier of the repeater 703 (e.g., 806 in FIG. 8) and/or a second identifier of the network node 704. In such aspects, the forwarded set of SRSs 708′ (e.g., 814′ in FIG. 8) may be received based on the donor indication (e.g., based on the first identifier of the repeater 703 (e.g., 806 in FIG. 8) and/or the second identifier of the network node 704).

At 1004, a network node obtains, based on the set of SRSs, an indication of at least one E2E measurement associated with communications for the UE. As an example, the obtaining may be performed, at least in part, by the component 199. FIG. 7 may illustrate an example of a network node (e.g., the network node 704) obtaining such an indication of at least one E2E measurement.

The network node 704 may be configured to obtain (at 710) (e.g., 818 in FIG. 8), based on the forwarded set of SRSs 708′ (e.g., 814′ in FIG. 8), an indication of at least one E2E measurement associated with communications for the UE 702 (e.g., 804 in FIG. 8). For instance, aspects herein provide that a repeater (e.g., the repeater 703 (e.g., 806 in FIG. 8)) may forward UL SRSs (e.g., the forwarded set of SRSs 708′ (e.g., 814′ in FIG. 8)) to a network node (e.g., the network node 704, such as a gNB with a DU) and the network node may be configured to make positioning measurements on behalf of the repeater. As noted herein, signaling metrics may include, without limitation, at least one of an UL AoA, a Z-AoA, a ToA, a RToA, an SRS RSRP, a RxTx time difference of the network node, an SRS received path power (RSRPP), a time stamp, a measurement quality, a quasi-co-location (QCL) of a beam associated with the UL transmission, an SRS resource type, an SRS resource identifier, an antenna reference point (ARP) identifier, a line of sight (LoS) indication, or a non-line of sight (NLoS) indication. In aspects, the network node 704 (e.g., via a DU thereof) may be configured to calculate as part of the obtaining (at 710) (e.g., 818 in FIG. 8), angular information, including without limitation, an AoA, a Z-AoA, etc., when the network node 704 has a requisite amount of spatial direction information of the repeater 703 (e.g., 806 in FIG. 8). In such aspects, the network node 704 may map access beams of the repeater 703 to the angles. In aspects, the network node 704 may have information, including but not limited to, information associated with the amplification gain of the repeater 703 (e.g., 806 in FIG. 8), backhaul pathloss, and/or the like (e.g., where the SRS-RSRP may be equal to, or approximately equal to: E2E RSRP-(amplification gain-backhaul pathloss)). For example, in aspects, the network node 704 may be configured to measure a value of the SRS RSRP based on the E2E RSRP, the amplification gain of the repeater 703 (e.g., 806 in FIG. 8), and the backhaul pathloss associated with the forwarded set of SRSs 708′ (e.g., 814′ in FIG. 8), and the value of the SRS RSRP may be included the measurement information 712 (e.g., 820 in FIG. 8). In aspects, the E2E measurement associated with the communications for the UE 702 (e.g., 804 in FIG. 8) may include the E2E RSRP. Likewise, the network node 704 may calculate/derive (at 710) (e.g., 818 in FIG. 8) other signaling metrics, based on the forwarded set of SRSs 708′ (e.g., 814′ in FIG. 8), information associated therewith, and/or the indication of at least one E2E measurement associated with communications for the UE 702 (e.g., 804 in FIG. 8), as obtained (at 710) (e.g., 818 in FIG. 8). In aspects, the network node 704 may be configured to calculate signaling metrics associated with timing (e.g., the RTOA, the RxTx time difference of the network node, etc., based on information associated with the backhaul channel propagation delay and the internal delay associated with the repeater 703 (e.g., 806 in FIG. 8).

At 1006, a network node transmits, for a network entity, measurement information, where the measurement information includes the at least one E2E measurement associated with the communications for the UE. As an example, the transmission may be performed, at least in part, by the component 199. FIG. 7 may illustrate an example of a network node (e.g., the network node 704) transmitting such measurement information to a network entity (e.g., the LMF 705).

When the network node 704 has the requisite amount of information, calculated/derived (at 710) (e.g., at 824 in FIG. 8) positioning measurements and/or signaling metrics obtained by the network node 704 for the repeater 703 (e.g., 806 in FIG. 8) may be provided by the network node 704 to the LMF 705 (e.g., 808 in FIG. 8) as measurement information 712 (e.g., 820 in FIG. 8). In some aspects, the measurement information obtained (at 710) (e.g., 818 in FIG. 8) may include at least one of an angle associated with the at least one beam or an identifier of the at least one beam of the repeater 703 (e.g., 806 in FIG. 8) (e.g., as illustrated for the TRP 402 in FIG. 4). In some aspects, the measurement information may include a first identifier of the wireless device and/or a second identifier of the network node. If the network node 704 (e.g., via a DU thereof) does not have a requisite amount of information to determine/calculate (at 710) (e.g., at 824 in FIG. 8) positioning measurements based on the forwarded set of SRSs 708′ (e.g., 814′ in FIG. 8), information associated therewith, and/or the indication of the E2E measurement, the network node 704 may indicate to the LMF 705 (e.g., 808 in FIG. 8) at least the indication of the E2E measurement, and any other information determined (e.g., the identity of a beam(s) of the repeater 703 (e.g., 806 in FIG. 8) used to detect/measure the set of SRSs 708 (e.g., 814 in FIG. 8), as described above, in the measurement information 712 (e.g., 820 in FIG. 8). In aspects, the LMF 705 (e.g., 808 in FIG. 8) may be configured to derive/calculate (e.g., 824 in FIG. 8) angular information for the UE 702 (e.g., 804 in FIG. 8) based on the measurement information 712 (e.g., 820 in FIG. 8).

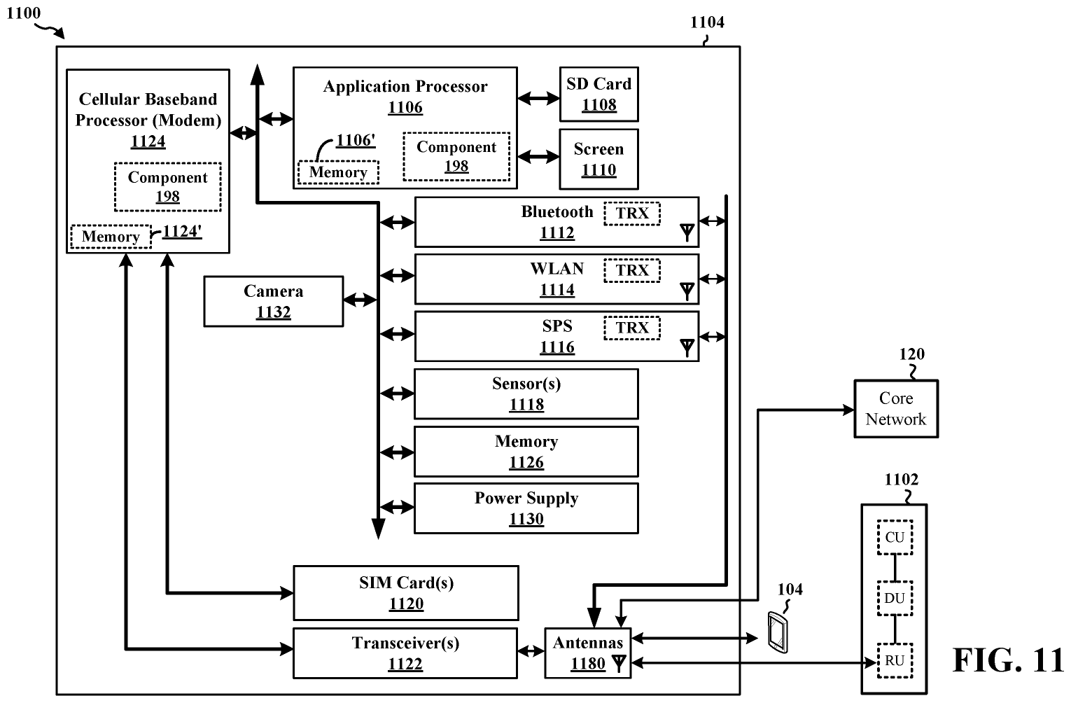

FIG. 11 is a diagram 1100 illustrating an example of a hardware implementation for an apparatus 1104. The apparatus 1104 may be a UE, a component of a UE, or may implement UE functionality. In some aspects, the apparatus 1104 may include a cellular baseband processor 1124 (also referred to as a modem) coupled to one or more transceivers 1122 (e.g., cellular RF transceiver). The cellular baseband processor 1124 may include on-chip memory 1124′. In some aspects, the apparatus 1104 may further include one or more subscriber identity modules (SIM) cards 1120 and an application processor 1106 coupled to a secure digital (SD) card 1108 and a screen 1110. The application processor 1106 may include on-chip memory 1106′. In some aspects, the apparatus 1104 may further include a Bluetooth module 1112, a WLAN module 1114, an SPS module 1116 (e.g., GNSS module), one or more sensor modules 1118 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1126, a power supply 1130, and/or a camera 1132. The Bluetooth module 1112, the WLAN module 1114, and the SPS module 1116 may include an on-chip transceiver (TRX) (or in some cases, just a receiver (RX)). The Bluetooth module 1112, the WLAN module 1114, and the SPS module 1116 may include their own dedicated antennas and/or utilize the antennas 1180 for communication. The cellular baseband processor 1124 communicates through the transceiver(s) 1122 via one or more antennas 1180 with the UE 104, with the core network 120, and/or with an RU associated with a network entity 1102. The cellular baseband processor 1124 and the application processor 1106 may each include a computer-readable medium/memory 1124′, 1106′, respectively. The additional memory modules 1126 may also be considered a computer-readable medium/memory. Each computer-readable medium/memory 1124′, 1106′, 1126 may be non-transitory. The cellular baseband processor 1124 and the application processor 1106 are each responsible for general processing, including the execution of software stored on the computer-readable medium/memory. The software, when executed by the cellular baseband processor 1124/application processor 1106, causes the cellular baseband processor 1124/application processor 1106 to perform the various functions described supra. The computer-readable medium/memory may also be used for storing data that is manipulated by the cellular baseband processor 1124/application processor 1106 when executing software. The cellular baseband processor 1124/application processor 1106 may be a component of the UE 350 and may include the memory 360 and/or at least one of the TX processor 368, the RX processor 356, and the controller/processor 359. In one configuration, the apparatus 1104 may be a processor chip (modem and/or application) and include just the cellular baseband processor 1124 and/or the application processor 1106, and in another configuration, the apparatus 1104 may be the entire UE (e.g., see UE 350 of FIG. 3) and include the additional modules of the apparatus 1104.

As discussed supra, the component 198 may be configured to obtain a SRS configuration for a UE, the SRS configuration including information associated with positioning of the UE. The component 198 may also be configured to perform at least one positioning measurement based on an UL transmission from the UE and the information associated with the positioning of the UE. The component 198 may be further configured to transmit, for a network node, an indication of the at least one positioning measurement. The component 198 may be configured to transmit, for the network node, a frequency indication that indicates at least one frequency associated with at least one of the one or more signaling metrics. The component 198 may be configured to transmit, for the network node, a support indication that indicates at least one of an accuracy, a processing latency, a maximum number of supported measurements, a first indication of support for at least one of periodic measurements or aperiodic measurements, a second indication of support for at least one of periodic measurement reports or aperiodic measurement reports, a number of paths supported for measurements per SRS associated with at least one of the one or more signaling metrics, or at least one of the one or more signaling metrics that are supported by the wireless device. The component 198 may be configured to receive, from the network node, a side control configuration, where the side control configuration indicates at least one of a timing adjustment associated with receive-forward timing of a set of SRSs or a configured gain associated with transmission of the set of SRSs. The component 198 may be further configured to perform any of the aspects described in connection with the flowcharts in any of FIGS. 9, 10, and/or any of the aspects performed by a wireless device for any of FIGS. 5-8. The component 198 may be within the cellular baseband processor 1124, the application processor 1106, or both the cellular baseband processor 1124 and the application processor 1106. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1104 may include a variety of components configured for various functions. In one configuration, the apparatus 1104, and in particular the cellular baseband processor 1124 and/or the application processor 1106, may include means for obtaining a SRS configuration for a UE, the SRS configuration including information associated with positioning of the UE. In the configuration, the apparatus 1104, and in particular the cellular baseband processor 1124 and/or the application processor 1106, may include means for performing at least one positioning measurement based on an UL transmission from the UE and the information associated with the positioning of the UE. In the configuration, the apparatus 1104, and in particular the cellular baseband processor 1124 and/or the application processor 1106, may include means for transmitting, for a network node, an indication of the at least one positioning measurement. In one configuration, the apparatus 1104, and in particular the cellular baseband processor 1124 and/or the application processor 1106, may include means for transmitting, for the network node, a frequency indication that indicates at least one frequency associated with at least one of the one or more signaling metrics. In one configuration, the apparatus 1104, and in particular the cellular baseband processor 1124 and/or the application processor 1106, may include means for transmitting, for the network node, a support indication that indicates at least one of an accuracy, a processing latency, a maximum number of supported measurements, a first indication of support for at least one of periodic measurements or aperiodic measurements, a second indication of support for at least one of periodic measurement reports or aperiodic measurement reports, a number of paths supported for measurements per SRS associated with at least one of the one or more signaling metrics, or at least one of the one or more signaling metrics that are supported by the wireless device. In one configuration, the apparatus 1104, and in particular the cellular baseband processor 1124 and/or the application processor 1106, may include means for receiving, from the network node, a side control configuration, where the side control configuration indicates at least one of a timing adjustment associated with receive-forward timing of a set of SRSs or a configured gain associated with transmission of the set of SRSs. The means may be the component 198 of the apparatus 1104 configured to perform the functions recited by the means. As described supra, the apparatus 1104 may include the TX processor 368, the RX processor 356, and the controller/processor 359. As such, in one configuration, the means may be the TX processor 368, the RX processor 356, and/or the controller/processor 359 configured to perform the functions recited by the means.

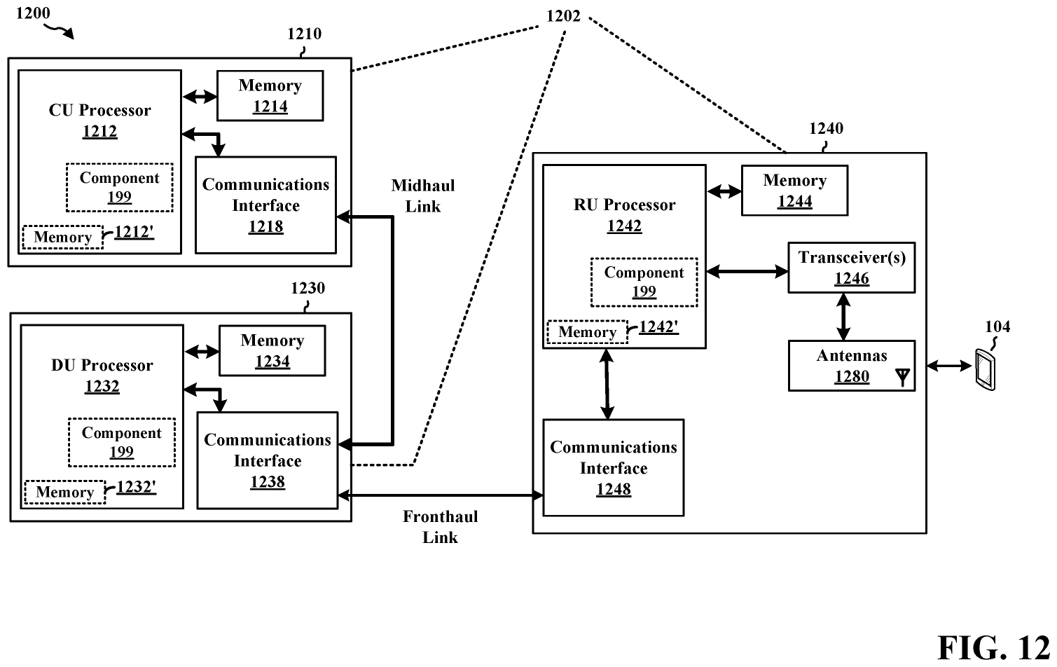

FIG. 12 is a diagram 1200 illustrating an example of a hardware implementation for a network entity 1202. The network entity 1202 may be a BS, a component of a BS, or may implement BS functionality. The network entity 1202 may include at least one of a CU 1210, a DU 1230, or an RU 1240. For example, depending on the layer functionality handled by the component 199, the network entity 1202 may include the CU 1210; both the CU 1210 and the DU 1230; each of the CU 1210, the DU 1230, and the RU 1240; the DU 1230; both the DU 1230 and the RU 1240; or the RU 1240. The CU 1210 may include a CU processor 1212. The CU processor 1212 may include on-chip memory 1212′. In some aspects, the CU 1210 may further include additional memory modules 1214 and a communications interface 1218. The CU 1210 communicates with the DU 1230 through a midhaul link, such as an F1 interface. The DU 1230 may include a DU processor 1232. The DU processor 1232 may include on-chip memory 1232′. In some aspects, the DU 1230 may further include additional memory modules 1234 and a communications interface 1238. The DU 1230 communicates with the RU 1240 through a fronthaul link. The RU 1240 may include an RU processor 1242. The RU processor 1242 may include on-chip memory 1242′. In some aspects, the RU 1240 may further include additional memory modules 1244. one or more transceivers 1246, antennas 1280, and a communications interface 1248. The RU 1240 communicates with the UE 104. The on-chip memory 1212′, 1232′. 1242′ and the additional memory modules 1214, 1234, 1244 may each be considered a computer-readable medium/memory. Each computer-readable medium/memory may be non-transitory. Each of the processors 1212, 1232, 1242 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to receive, from a UE via a wireless device, a set of SRSs. The component 199 may also be configured to obtain, based on the set of SRSs, an indication of at least one E2E measurement associated with communications for the UE. The component 199 may be further configured to transmit, for a network entity, measurement information, where the measurement information includes the at least one E2E measurement associated with the communications for the UE. The component 199 may be further configured to transmit, for the wireless device, a side control configuration, where the side control configuration indicates at least one of a timing adjustment associated with receive-forward timing of the set of SRSs or a configured gain associated with transmission of the set of SRSs. The component 199 may be further configured to measure a value of the SRS RSRP based on an E2E RSRP, an amplification gain, and a backhaul pathloss associated with the set of SRSs, where the measurement information includes the value of the SRS RSRP. The component 199 may be further configured to receive, from the network entity, a donor indication that indicates at least one of the first identifier of the wireless device or the second identifier of the network node. The component 199 may be further configured to receive, from a second network node, an activation for obtaining the at least one E2E measurement associated with communications for the UE. The component 199 may be further configured to receive, from the wireless device, an indication of at least one positioning measurement, where the at least one positioning measurement is based on an uplink (UL) transmission from the UE and the information associated with the positioning of the UE, where the at least one E2E measurement is associated with the at least one positioning measurement. The component 199 may be further configured to perform any of the aspects described in connection with the flowcharts in any of FIGS. 9, 10, and/or any of the aspects performed by a wireless device for any of FIGS. 5-8. The component 199 may be within one or more processors of one or more of the CU 1210, DU 1230, and the RU 1240. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1202 may include a variety of components configured for various functions. In one configuration, the network entity 1202 may include means for receiving, from a UE via a wireless device, a set of SRSs. In the configuration, the network entity 1202 may include means for obtaining, based on the set of SRSs, an indication of at least one E2E measurement associated with communications for the UE. In the configuration, the network entity 1202 may include means for transmitting, for a network entity, measurement information, where the measurement information includes the at least one E2E measurement associated with the communications for the UE. In one configuration, the network entity 1202 may include means for transmitting, for the wireless device, a side control configuration, where the side control configuration indicates at least one of a timing adjustment associated with receive-forward timing of the set of SRSs or a configured gain associated with transmission of the set of SRSs. In one configuration, the network entity 1202 may include means for measuring a value of the SRS RSRP based on an E2E RSRP, an amplification gain, and a backhaul pathloss associated with the set of SRSs, where the measurement information includes the value of the SRS RSRP. In one configuration, the network entity 1202 may include means for receiving, from the network entity, a donor indication that indicates at least one of the first identifier of the wireless device or the second identifier of the network node. In one configuration, the network entity 1202 may include means for receiving, from a second network node, an activation for obtaining the at least one E2E measurement associated with communications for the UE. In one configuration, the network entity 1202 may include means for receiving, from the wireless device, an indication of at least one positioning measurement, where the at least one positioning measurement is based on an uplink (UL) transmission from the UE and the information associated with the positioning of the UE, where the at least one E2E measurement is associated with the at least one positioning measurement. The means may be the component 199 of the network entity 1202 configured to perform the functions recited by the means. As described supra, the network entity 1202 may include the TX processor 316, the RX processor 370, and the controller/processor 375. As such, in one configuration, the means may be the TX processor 316, the RX processor 370, and/or the controller/processor 375 configured to perform the functions recited by the means.

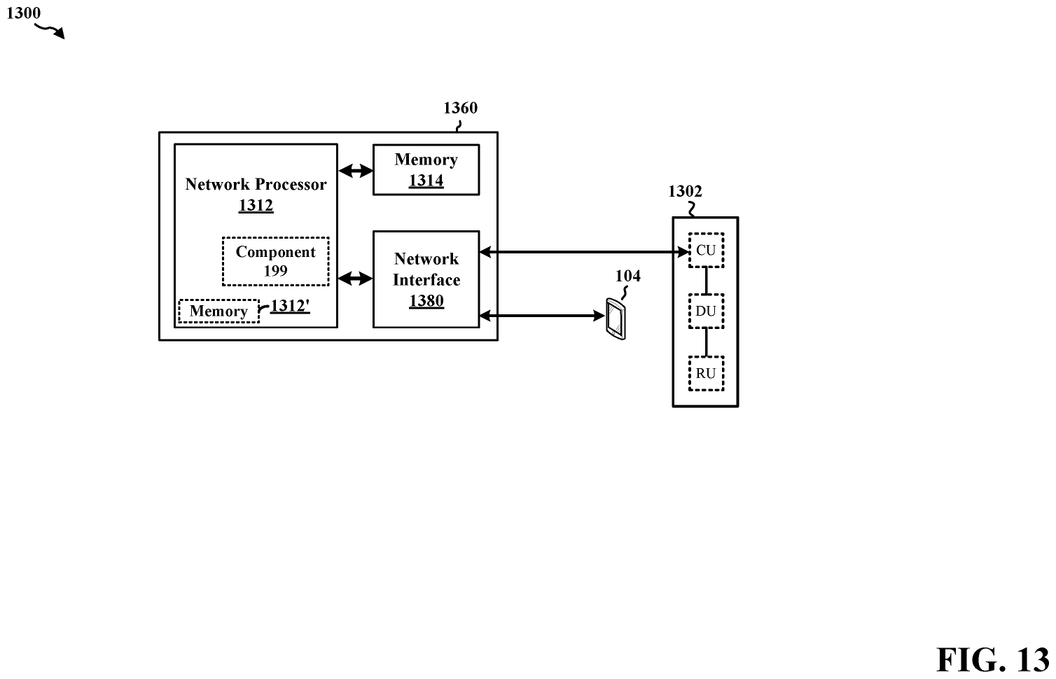

FIG. 13 is a diagram 1300 illustrating an example of a hardware implementation for a network entity 1360. In one example, the network entity 1360 may be within the core network 120. The network entity 1360 may include a network processor 1312. The network processor 1312 may include on-chip memory 1312′. In some aspects, the network entity 1360 may further include additional memory modules 1314. The network entity 1360 communicates via the network interface 1380 directly (e.g., backhaul link) or indirectly (e.g., through a RIC) with the CU 1302 and/or with the UE 104. The on-chip memory 1312′ and the additional memory modules 1314 may each be considered a computer-readable medium/memory. Each computer-readable medium/memory may be non-transitory. The processor 1312 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to obtain measurement information, where the measurement information includes one or more measurement values, where the one or more measurement values include at least one of (1) an E2E measurement associated with communications for a UE or (2) at least one adjusted measurement associated with the communications for the UE. The component 199 may be configured to obtain a set of positioning metrics for the UE based on the measurement information. The component 199 may be configured to output the set of positioning metrics for the UE. The component 199 may be configured to provide, for a network node, a donor indication that indicates at least one TRP, where the at least one TRP is associated with the E2E measurement. The component 199 may be further configured to perform any of the aspects described in connection with the flowcharts in any of FIGS. 9, 10, and/or any of the aspects performed by a wireless device for any of FIGS. 5-8. The component 199 may be within the processor 1312. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1360 may include a variety of components configured for various functions. In one configuration, the network entity 1360 may include means for obtaining measurement information, where the measurement information includes one or more measurement values, where the one or more measurement values include at least one of (1) an E2E measurement associated with communications for a UE or (2) at least one adjusted measurement associated with the communications for the UE. In the configuration, the network entity 1360 may include means for obtaining a set of positioning metrics for the UE based on the measurement information. In the configuration, the network entity 1360 may include means for outputting the set of positioning metrics for the UE. In one configuration, the network entity 1360 may include means for providing, for a network node, a donor indication that indicates at least one TRP, where the at least one TRP is associated with the E2E measurement. The means may be the component 199 of the network entity 1360 configured to perform the functions recited by the means.

A wireless communication network and/or a wireless device may utilize measurements associated with specific signaling to enable the determination of one or more angles of arrival, power levels of transmitted/received signals such as RSRP, line of sight/non-line of sight information, etc., utilized for positioning operations in a positioning session. As one example, a network node, such as a base station, may provide DL signaling for a wireless device, such as a UE, which may respond with corresponding UL signaling from which the one or more angles of arrival, power levels of transmitted/received signals such as RSRP, line of sight/non-line of sight information, etc., may be determined. Based on the received signaling, the network node, or a network entity, such as a LMF, may perform operations to determine positioning of the wireless device. However, scenarios may arise in which such signaling may not be adequate to determine accurate positioning for the wireless device. For instance, a network node may communicate/exchange communications/signaling with a wireless device via another wireless device such as a repeater. A repeater (e.g., a NCR) may be used to receive/forward positioning references for positioning of a wireless device. In some cases, such a repeater may forward DL/UL signaling between a network node and a wireless device (e.g., with no or minimal processing), and the network node is thus the logical source/destination of DL/UL signaling with respect to the wireless device. Yet, the positioning and transmission characteristics of the repeater, e.g., for transmission power levels, should be considered as the repeater is the physical source/destination for positioning purposes, in such scenarios.

Aspects described herein for UL-based positioning via a repeater improve positioning sessions and positioning determinations for wireless devices. In some examples, a wireless device may be configured to obtain a SRS configuration for a UE, where the SRS configuration includes information associated with positioning of the UE. The wireless device may also be configured to perform at least one positioning measurement based on an UL transmission from the UE and the information associated with the positioning of the UE. The wireless device may also be configured to transmit, for a network node, an indication of the at least one positioning measurement. In some examples, a network node may be configured to receive, from a UE via a wireless device, a set of SRSs. The network node may also be configured to obtain, based on the set of SRSs, an indication of at least one E2E measurement associated with communications for the UE. The network node may be further configured to transmit, for a network entity, measurement information, where the measurement information includes the at least one E2E measurement associated with the communications for the UE. The described aspects provide new signaling and procedures for positioning sessions in configurations that utilize repeaters in between wireless devices and network nodes, and enable UL-based positioning via a repeater. The described aspects also provide a repeater with UE-configured information, that may be used to determine positioning of wireless devices by repeaters. In some examples, by considering the one or more angles of arrival, power levels of transmitted/received signals such as RSRP, line of sight/non-line of sight information, signaling at, and/or positioning of, a repeater and providing such information from the repeater to a network node via UL signaling when performing a positioning session, more accurate determinations for positioning of wireless devices that communicate via repeaters are enabled. Additionally, a network node and/or a network entity are enabled through the described aspects to be aware of the position-related signaling from a wireless device via a repeater, and more accurate positioning for the wireless device may be determined. Aspects also provide the E2E measurements from a network node (e.g., a base station) to a network entity (e.g., a LMF) for positioning calculations/determinations in positioning sessions by measuring at a network node E2E measurements for UE position-related signaling via a repeater.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X. X would include one or more elements. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.
Aspect 1 is a method of wireless communication at a wireless device, including: obtaining a sounding reference signal (SRS) configuration for a user equipment (UE), the SRS configuration including information associated with positioning of the UE; performing at least one positioning measurement based on an uplink (UL) transmission from the UE and the information associated with the positioning of the UE; and transmitting, for a network node, an indication of the at least one positioning measurement.
Aspect 2 is the method of aspect 1, where transmitting the indication of the at least one positioning measurement includes: transmitting, to the network node, the indication of the at least one positioning measurement via radio resource control (RRC) signaling, a medium access control (MAC) control element (MAC-CE), or uplink control information (UCI).
Aspect 3 is the method of aspect 2, where transmitting the indication of the at least one positioning measurement includes transmitting the indication of the at least one positioning measurement based on at least one of an F1 access protocol (F1AP) signaling information element (IE) or a new radio positioning protocol A (NRPPa) signaling IE.
Aspect 4 is the method of any of aspects 1 to 3, where obtaining the SRS configuration for the UE includes receiving, from the network node, the SRS configuration via radio resource control (RRC) signaling, a medium access control (MAC) control element (MAC-CE), or downlink control information (DCI).
Aspect 5 is the method of any of aspects 1 to 4, where the at least one positioning measurement includes one or more signaling metrics including: at least one of an UL angle of arrival (AoA), a zenith AoA (Z-AoA), a time of arrival (ToA), a relative ToA (RToA), an SRS received power (RSRP), a reception-transmission (RxTx) time difference of the network node, an SRS received path power (RSRPP), a time stamp, a measurement quality, a quasi-co-location (QCL) of a beam associated with the UL transmission, an SRS resource type, an SRS resource identifier, an antenna reference point (ARP) identifier, a line of sight (LoS) indication, or a non-line of sight (NLoS) indication.
Aspect 6 is the method of aspect 5, where the one or more signaling metrics include at least one soft signaling metric that is based on an estimation associated with the UL transmission.
Aspect 7 is the method of aspect 5, further including: transmitting, for the network node, a frequency indication that indicates at least one frequency associated with at least one of the one or more signaling metrics.
Aspect 8 is the method of aspect 5, further including: transmitting, for the network node, a support indication that indicates includes at least one of an accuracy, a processing latency, a maximum number of supported measurements, a first indication of support for at least one of periodic measurements or aperiodic measurements, a second indication of support for at least one of periodic measurement reports or aperiodic measurement reports, or a number of paths supported for measurements per SRS associated with at least one of the one or more signaling metrics, or at least one of the one or more signaling metrics that are supported by the wireless device.
Aspect 9 is the method of any of aspects 1 to 8, further including: receiving, from the network node, a side control configuration, where the side control configuration indicates at least one of a timing adjustment associated with receive-forward timing of a set of SRSs or a configured gain associated with transmission of the set of SRSs.
Aspect 10 is the method of any of aspects 1 to 9, where the wireless device is a network controlled repeater (NCR) and the network node is a base station.
Aspect 11 is a method of wireless communication at a network node, including: receiving, from a user equipment (UE) via a wireless device, a set of sounding reference signals (SRSs); obtaining, based on the set of SRSs, an indication of at least one end-to-end (E2E) measurement associated with communications for the UE; and transmitting, for a network entity, measurement information, where the measurement information includes the at least one E2E measurement associated with the communications for the UE.
Aspect 12 is the method of aspect 11, further including: transmitting, for the wireless device, a side control configuration, where the side control configuration indicates at least one of a timing adjustment associated with receive-forward timing of the set of SRSs or a configured gain associated with transmission of the set of SRSs.
Aspect 13 is the method of aspect 12, where receiving the set of SRSs includes receiving the set of SRSs based on at least one of the timing adjustment associated with the receive-forward timing of the set of SRSs or the configured gain associated with the transmission of the set of SRSs.
Aspect 14 is the method of aspect 13, where receiving the set of SRSs includes: receiving the set of SRSs with a transmitted gain that is different from the configured gain associated with the transmission of the set of SRSs; and receiving gain difference information that indicates a difference between the transmitted gain and the configured gain associated with the transmission of the set of SRSs.
Aspect 15 is the method of any of aspects 11 to 14, where receiving the set of SRSs includes receiving the set of SRSs via at least one beam of the wireless device; where the measurement information includes at least one of an angle associated with the at least one beam or an identifier of the at least one beam of the wireless device.
Aspect 16 is the method of any of aspects 11 to 15, where the measurement information includes one or more signaling metrics including: at least one of an uplink (UL) angle of arrival (AoA), a zenith AoA (Z-AoA), a time of arrival (ToA), a relative ToA (RToA), an SRS received power (RSRP), an reception-transmission (RxTx) time difference of the network node, an SRS received path power (RSRPP), a time stamp, a measurement quality, a quasi-co-location (QCL) of a beam associated with an UL transmission from the UE, an SRS resource type, an SRS resource identifier, an antenna reference point (ARP) identifier, a line of sight (LoS) indication, or a non-line of sight (NLoS) indication; or where the at least one E2E measurement associated with the communications for the UE includes an E2E measurement associated with at least one of the one or more signaling metrics.
Aspect 17 is the method of aspect 16, where transmitting the measurement information includes transmitting at least one flag, where the at least one flag indicates at least one of an adjustment to the one or more signaling metrics of the measurement information respectively or an E2E indication for the at least one E2E measurement respectively.
Aspect 18 is the method of aspect 16, where the method further includes: measuring a value of the SRS RSRP based on an E2E RSRP, an amplification gain, and a backhaul pathloss associated with the set of SRSs, where the measurement information includes the value of the SRS RSRP; or where the at least one E2E measurement associated with the communications for the UE includes the E2E RSRP.
Aspect 19 is the method of any of aspects 11 to 18, where the measurement information further includes at least one of a first identifier of the wireless device or a second identifier of the network node.
Aspect 20 is the method of aspect 19, further including: receiving, from the network entity, a donor indication that indicates at least one of the first identifier of the wireless device or the second identifier of the network node; and where receiving the set of SRSs includes receiving the set of SRSs based on the donor indication.
Aspect 21 is the method of aspect 20, further including: receiving, from a second network node, an activation for the at least one E2E measurement associated with the communications for the UE; where transmitting the measurement information includes transmitting the measurement information, for the network entity, via the second network node.
Aspect 22 is the method of any of aspects 11 to 21, where the network entity is a location management function (LMF), the wireless device is a network controlled repeater (NCR), and the network node is a base station.
Aspect 23 is the method of any of aspects 11 to 22, further including: receiving, from the wireless device, an indication of at least one positioning measurement, where the at least one positioning measurement is based on an uplink (UL) transmission from the UE and the information associated with the positioning of the UE, where the at least one E2E measurement is associated with the at least one positioning measurement.
Aspect 24 is the method of aspect 23, where receiving the indication of the at least one positioning measurement includes: receiving, from the wireless device, the indication of the at least one positioning measurement via radio resource control (RRC) signaling, a medium access control (MAC) control element (MAC-CE), or uplink control information (UCI).
Aspect 25 is the method of aspect 24, where receiving the indication of the at least one positioning measurement includes receiving the indication of the at least one positioning measurement based on at least one of an F1 access protocol (F1AP) signaling information element (IE) or a new radio positioning protocol A (NRPPa) signaling IE.
Aspect 26 is an apparatus for wireless communication including means for implementing any of aspects 1 to 11.
Aspect 27 is a computer-readable medium (e.g., a non-transitory computer-readable medium) storing computer executable code, the code when executed by at least one processor causes the at least one processor to implement any of aspects 1 to 11.
Aspect 28 is an apparatus for wireless communication at a network node. The apparatus includes a memory; and at least one processor coupled to the memory and, based at least in part on information stored in the memory, the at least one processor is configured to implement any of aspects 1 to 11.
Aspect 29 is the apparatus of aspect 28, further including at least one of a transceiver or an antenna coupled to the at least one processor.
Aspect 30 is an apparatus for wireless communication including means for implementing any of aspects 12 to 25.
Aspect 31 is a computer-readable medium (e.g., a non-transitory computer-readable medium) storing computer executable code, the code when executed by at least one processor causes the at least one processor to implement any of aspects 12 to 25.
Aspect 32 is an apparatus for wireless communication at a network node. The apparatus includes a memory; and at least one processor coupled to the memory and, based at least in part on information stored in the memory, the at least one processor is configured to implement any of aspects 12 to 25.
Aspect 33 is the apparatus of aspect 32, further including at least one of a transceiver or an antenna coupled to the at least one processor.
Aspect 34 is a method of wireless communication at a network entity, including: obtaining measurement information, where the measurement information includes one or more measurement values, where the one or more measurement values include at least one of (1) an end-to-end (E2E) measurement associated with communications for a user equipment (UE) or (2) at least one adjusted measurement associated with the communications for the UE; obtaining a set of positioning metrics for the UE based on the measurement information; and outputting the set of positioning metrics for the UE.
Aspect 35 is the method of aspect 34, where obtaining the set of positioning metrics for the UE based on the measurement information includes at least one of: processing the E2E measurement to obtain at least a first portion of the set of positioning metrics for the UE; or including the at least one adjusted measurement as at least a second portion of the set of positioning metrics for the UE.
Aspect 36 is the method of any of aspects 34 and 35, where outputting the set of positioning metrics for the UE includes at least one of processing the positioning metrics or providing the positioning metrics for the UE.
Aspect 37 is the method of any of aspects 34 to 36, further including: providing, for a network node, a donor indication that indicates at least one transmission-reception point (TRP), where the at least one TRP is associated with the E2E measurement.
Aspect 38 is the method of aspect 37, where the measurement information further includes at least one of: a donor identifier associated with the at least one TRP; at least one type indication respectively corresponding to at least one of the one or more measurement values, where each type indication indicates an E2E type or an adjusted type; or a mapping of at least one access beam to at least one corresponding angle of arrival.
Aspect 39 is an apparatus for wireless communication including means for implementing any of aspects 34 to 38.
Aspect 40 is a computer-readable medium (e.g., a non-transitory computer-readable medium) storing computer executable code, the code when executed by at least one processor causes the at least one processor to implement any of aspects 34 to 38.
Aspect 41 is an apparatus for wireless communication at a network node. The apparatus includes a memory; and at least one processor coupled to the memory and, based at least in part on information stored in the memory, the at least one processor is configured to implement any of aspects 34 to 38.
Aspect 42 is the apparatus of aspect 41, further including at least one of a transceiver or an antenna coupled to the at least one processor.

What is claimed is:

1. An apparatus for wireless communication at a wireless device, comprising:
a memory; and
at least one processor coupled to the memory and, based at least in part on first information stored in the memory, the at least one processor is configured to:
obtain a sounding reference signal (SRS) configuration for a user equipment (UE), the SRS configuration including information associated with positioning of the UE;
perform at least one positioning measurement based on an uplink (UL) transmission from the UE and the information associated with the positioning of the UE; and
transmit, for a network node, an indication of the at least one positioning measurement.

2. The apparatus of claim 1, wherein to transmit the indication of the at least one positioning measurement, the at least one processor is configured to: transmit, to the network node, the indication of the at least one positioning measurement via radio resource control (RRC) signaling, a medium access control (MAC) control element (MAC-CE), or uplink control information (UCI).

3. The apparatus of claim 2, wherein to transmit the indication of the at least one positioning measurement, the at least one processor is configured to transmit the indication of the at least one positioning measurement based on at least one of an F1 access protocol (F1AP) signaling information element (IE) or a new radio positioning protocol A (NRPPa) signaling IE.

4. The apparatus of claim 1, wherein to obtain the SRS configuration for the UE, the at least one processor is configured to receive, from the network node, the SRS configuration via radio resource control (RRC) signaling, a medium access control (MAC) control element (MAC-CE), or downlink control information (DCI).

5. The apparatus of claim 1, wherein the at least one positioning measurement includes one or more signaling metrics comprising: at least one of an UL angle of arrival (AoA), a zenith AoA (Z-AoA), a time of arrival (ToA), a relative ToA (RToA), an SRS received power (RSRP), a reception-transmission (RxTx) time difference of the network node, an SRS received path power (RSRPP), a time stamp, a measurement quality, a quasi-co-location (QCL) of a beam associated with the UL transmission, an SRS resource type, an SRS resource identifier, an antenna reference point (ARP) identifier, a line of sight (LoS) indication, or a non-line of sight (NLoS) indication.

6. The apparatus of claim 5, wherein the one or more signaling metrics include at least one soft signaling metric that is based on an estimation associated with the UL transmission.

7. The apparatus of claim 5, wherein the at least one processor is further configured to:
transmit, for the network node, a frequency indication that indicates at least one frequency associated with at least one of the one or more signaling metrics.

8. The apparatus of claim 5, wherein the at least one processor is further configured to:
transmit, for the network node, a support indication that indicates at least one of an accuracy, a processing latency, a maximum number of supported measurements, a first indication of support for at least one of periodic measurements or aperiodic measurements, a second indication of support for at least one of periodic measurement reports or aperiodic measurement reports, a number of paths supported for measurements per SRS associated with at least one of the one or more signaling metrics, or at least one of the one or more signaling metrics that are supported by the wireless device.

9. The apparatus of claim 1, wherein the at least one processor is further configured to:
receive, from the network node, a side control configuration, wherein the side control configuration indicates at least one of a timing adjustment associated with receive-forward timing of a set of SRSs or a configured gain associated with transmission of the set of SRSs.

10. The apparatus of claim 1, wherein the wireless device is a network controlled repeater (NCR) and the network node is a base station, and further comprising at least one of a transceiver or an antenna coupled to the at least one processor, wherein to obtain the SRS configuration, the at least one processor is configured to obtain, via at least one of the transceiver or the antenna, the SRS configuration.

11. An apparatus for wireless communication at a network node, comprising:
a memory; and
at least one processor coupled to the memory and, based at least in part on information stored in the memory, the at least one processor is configured to:
receive, from a user equipment (UE) via a wireless device, a set of sounding reference signals (SRSs);
obtain, based on the set of SRSs, an indication of at least one end-to-end (E2E) measurement associated with communications for the UE; and
transmit, for a network entity, measurement information, wherein the measurement information includes the at least one E2E measurement associated with the communications for the UE.

12. The apparatus of claim 11, wherein the at least one processor is further configured to:
transmit, for the wireless device, a side control configuration, wherein the side control configuration indicates at least one of a timing adjustment associated with receive-forward timing of the set of SRSs or a configured gain associated with transmission of the set of SRSs.

13. The apparatus of claim 12, wherein to receive the set of SRSs, the at least one processor is configured to: receive the set of SRSs based on at least one of the timing adjustment associated with the receive-forward timing of the set of SRSs or the configured gain associated with the transmission of the set of SRSs.

14. The apparatus of claim 12, wherein to receive the set of SRSs, the at least one processor is configured to:
receive the set of SRSs with a transmitted gain that is different from the configured gain associated with the transmission of the set of SRSs; and
receive gain difference information that indicates a difference between the transmitted gain and the configured gain associated with the transmission of the set of SRSs.

15. The apparatus of claim 11, wherein to receive the set of SRSs, the at least one processor is configured to: receive the set of SRSs via at least one beam of the wireless device;
wherein the measurement information includes at least one of an angle associated with the at least one beam or an identifier of the at least one beam of the wireless device.

16. The apparatus of claim 11, wherein the measurement information includes one or more signaling metrics comprising: at least one of an uplink (UL) angle of arrival (AoA), a zenith AoA (Z-AoA), a time of arrival (ToA), a relative ToA (RToA), an SRS received power (RSRP), an reception-transmission (RxTx) time difference of the network node, an SRS received path power (RSRPP), a time stamp, a measurement quality, a quasi-co-location (QCL) of a beam associated with an UL transmission from the UE, an SRS resource type, an SRS resource identifier, an antenna reference point (ARP) identifier, a line of sight (LoS) indication, or a non-line of sight (NLoS) indication; or
wherein the at least one E2E measurement associated with the communications for the UE includes an E2E measurement associated with at least one of the one or more signaling metrics.

17. The apparatus of claim 16, wherein to transmit the measurement information, the at least one processor is configured to: transmit at least one flag, wherein the at least one flag indicates at least one of an adjustment to the one or more signaling metrics of the measurement information respectively or an E2E indication for the at least one E2E measurement respectively.

18. The apparatus of claim 16, wherein the at least one processor is further configured to: measure a value of the SRS RSRP based on an E2E RSRP, an amplification gain, and a backhaul pathloss associated with the set of SRSs, wherein the measurement information includes the value of the SRS RSRP; or
wherein the at least one E2E measurement associated with the communications for the UE includes the E2E RSRP.

19. The apparatus of claim 11, wherein the measurement information further includes at least one of a first identifier of the wireless device or a second identifier of the network node.

20. The apparatus of claim 19, wherein the at least one processor is further configured to:
receive, from the network entity, a donor indication that indicates at least one of the first identifier of the wireless device or the second identifier of the network node; and
wherein to receive the set of SRSs, the at least one processor is configured to: receive the set of SRSs based on the donor indication.

21. The apparatus of claim 20, wherein the at least one processor is further configured to:
receive, from a second network node, an activation for the at least one E2E measurement associated with the communications for the UE;
wherein to transmit the measurement information, the at least one processor is configured to: transmit the measurement information, for the network entity, via the second network node.

22. The apparatus of claim 11, wherein the network entity is a location management function (LMF), the wireless device is a network controlled repeater (NCR), and the network node is a base station, and further comprising at least one of a transceiver or an antenna coupled to the at least one processor, wherein to receive the set of SRSs, the at least one processor is configured to receive, via at least one of the transceiver or the antenna, the set of SRSs.

23. The apparatus of claim 11, wherein the at least one processor is further configured to:
receive, from the wireless device, an indication of at least one positioning measurement, wherein the at least one positioning measurement is based on an uplink (UL) transmission from the UE and the information associated with the positioning of the UE, wherein the at least one E2E measurement is associated with the at least one positioning measurement.

24. The apparatus of claim 23, wherein to receive the indication of the at least one positioning measurement, the at least one processor is configured to: receive, from the wireless device, the indication of the at least one positioning measurement via radio resource control (RRC) signaling, a medium access control (MAC) control element (MAC-CE), or uplink control information (UCI).

25. The apparatus of claim 24, wherein to receive the indication of the at least one positioning measurement, the at least one processor is configured to: receive the indication of the at least one positioning measurement based on at least one of an F1 access protocol (F1AP) signaling information element (IE) or a new radio positioning protocol A (NRPPa) signaling IE.

26. A method of wireless communication at a wireless device, comprising:
obtaining a sounding reference signal (SRS) configuration for a user equipment (UE), the SRS configuration including information associated with positioning of the UE;
performing at least one positioning measurement based on an uplink (UL) transmission from the UE and the information associated with the positioning of the UE; and
transmitting, for a network node, an indication of the at least one positioning measurement.

27. The method of claim 26, wherein transmitting the indication of the at least one positioning measurement comprises: transmitting, to the network node, the indication of the at least one positioning measurement via radio resource control (RRC) signaling, a medium access control (MAC) control element (MAC-CE), or uplink control information (UCI);
wherein obtaining the SRS configuration for the UE includes receiving, from the network node, the SRS configuration via second RRC signaling, a second MAC-CE, or downlink control information (DCI).

28. The method of claim 26, further comprising at least one of:
transmitting, for the network node, a support indication that indicates at least one of an accuracy, a processing latency, a maximum number of supported measurements, a first indication of support for at least one of periodic measurements or aperiodic measurements, a second indication of support for at least one of periodic measurement reports or aperiodic measurement reports, a number of paths supported for measurements per SRS associated with at least one of one or more signaling metrics, or at least one of the one or more signaling metrics that are supported by the wireless device; or
receiving, from the network node, a side control configuration, wherein the side control configuration indicates at least one of a timing adjustment associated with receive-forward timing of a set of SRSs or a configured gain associated with transmission of the set of SRSs.

29. A method of wireless communication at a network node, comprising:
receiving, from a user equipment (UE) via a wireless device, a set of sounding reference signals (SRSs);
obtaining, based on the set of SRSs, an indication of at least one end-to-end (E2E) measurement associated with communications for the UE; and
transmitting, for a network entity, measurement information, wherein the measurement information includes the at least one E2E measurement associated with the communications for the UE.

30. The method of claim 29, further comprising at least one of:
transmitting, for the wireless device, a side control configuration, wherein the side control configuration indicates at least one of a timing adjustment associated with receive-forward timing of the set of SRSs or a configured gain associated with transmission of the set of SRSs, wherein receiving the set of SRSs includes receiving the set of SRSs based on at least one of the timing adjustment associated with the receive-forward timing of the set of SRSs or the configured gain associated with the transmission of the set of SRSs; or
receiving, from the wireless device, an indication of at least one positioning measurement, wherein the at least one positioning measurement is based on an uplink (UL) transmission from the UE and the information associated with the positioning of the UE, wherein the at least one E2E measurement is associated with the at least one positioning measurement.
